(19) United States
(12) Patent Application Publication
(10) Pub. No.: US 2022/0184916 A1
(43) Pub. Date: Jun. 16, 2022

(54) COEXTRUDED POLYMERIC LAYER

(71) Applicant: 3M INNOVATIVE PROPERTIES COMPANY, St. Paul, MN (US)

(72) Inventors: David F. Slama, City of Grant, MN (US); Garth V. Antila, Hudson, WI (US); Brent R. Hansen, New Richmond, MN (US); Caitlin E. Meree, St. Paul, MN (US)

(21) Appl. No.: 17/310,942

(22) PCT Filed: Mar. 11, 2020
(86) PCT No.: PCT/IB2020/052165

§ 371 Date: Sep. 1, 2021

Related U.S. Application Data
(60) Provisional application No. 62/820,539, filed on Mar. 19, 2019.

(51) Int. Cl. B32B 3/30; B32B 5/02; B32B 5/18; B32B 7/022; B32B 27/06; B32B 37/15

(52) U.S. Cl. CPC B32B 3/30; B32B 5/022; B32B 5/18; B32B 7/022; B32B 27/065; B32B 2307/732; B32B 5/028; B32B 2250/02; B32B 2307/536; B32B 2307/56; B32B 37/153

(57) ABSTRACT

Coextruded polymeric layer having first and second opposed major surfaces, the coextruded polymeric layer comprising foam and the coextruded polymeric layer comprising features extending from or into the first major surface by at least 100 micrometers, the first major surface comprising a first material having a first percent elongation at break, the second major surface comprising a second material having a second percent elongation at break, wherein the first percent elongation at break is greater than 100 percent of the second percent elongation at break. Coextended polymeric layers described herein are useful, for example, in vibration damping applications (e.g., a vibration damping laminate comprising a kinetic spacer comprising the coextruded polymeric layers).

### BACKGROUND

Foam products are commonly made by injection molding or by forming a large block of foam and then cutting the block into sheets. Converting processes such as convoluted cutting, hot wire, machining, and contour cutting is commonly used to provide shapes on surfaces of the sheets. Such shaped surfaces typically exhibit open cells.

Another common approach to making shaped foam is to cast a foamed film onto a casting roll to create a smooth surface foamed film. To create three-dimensional features, the film can be embossed, thereby compressing sections of the film. The cells in the compressed areas are crushed, permanently damaging the cell structure.

A third approach to making shaped foam is by profile extrusion, wherein foamed polymer is extruded through a profile die having the desired contour shape cut in the die. The resulting contoured foam shape is continuous in the down web direction. Uses of such shaped foams include gasket seals.

What is common with each of the methods is it produces a single layer material comprising of the one material. To obtain a multilayer material the typical method is to laminate or bond other materials to the foam sheet. The lamination process can be accomplished with an adhesive, hot lamination or using an extrusion process to provide a bonding layer between the foam sheet and the material it is being bonded to.

Alternative multilayer polymeric foams and/or methods for making polymeric foams are desired.

### SUMMARY

In one aspect, the present disclosure provides a coextruded polymeric layer having first and second opposed major surfaces, the coextruded polymeric layer comprising foam and the coextruded polymeric layer comprising features extending from or into the first major surface by at least 100 (in some embodiments, at least 200, 300, 500, 750, 1000, 2500, 5000, 7500, 10,000, or even at least 12,700; in a range from 100 to 1000, 1000 to 6000, 6000 to 12,700 or even 12,700 to 25,400) micrometers, the first major surface comprising a first material having a first percent elongation at break, the second major surface comprising a second material having a second percent elongation at break, wherein the first percent elongation at break is greater than 100 (in some embodiments, at least 125, 150, or even at least 200) percent of the second percent elongation at break.

In another aspect, the present disclosure provides a first method for making a coextruded polymeric layer described herein, the method comprising:

providing a rotating tool roll having a major circumferential surface and a coextrusion die with a die lip spaced in proximity of the rotating tool roll to form a gap between the rotating tool roll and the coextrusion die; and

coextruding at least first and second polymers from the coextrusion die onto a portion of the major circumferential surface of the rotating tool roll, wherein at least one of the first or second polymers comprises a forming agent, and wherein the portion of the major circumferential surface is in proximity of the die lip

to provide the coextruded polymeric layer.

In another aspect, the present disclosure provides a second method for making a coextruded polymeric layer described herein, the method comprising:

providing a rotating tool roll having a major circumferential surface and a coextrusion die with a die lip spaced in proximity of the rotating tool roll to form a gap between the rotating tool roll and the coextrusion die; and

coextruding at least first and second polymers from the coextrusion die onto a portion of the major circumferential surface of the rotating tool roll, wherein the portion of the major circumferential surface is in proximity of the die lip, wherein a gas is injected into at least one of the first or second polymers prior the polymer contacting the portion of the major circumferential surface of the rotating tool roll and, wherein the extruded polymer foams to provide the coextruded polymeric layer.

In another aspect, the present disclosure provides a third method for making a coextruded polymeric layer described herein, the method comprising:

providing a rotating tool roll having a major circumferential surface and a coextrusion die with a die lip spaced in proximity of the rotating tool roll to form a gap between the rotating tool roll and the coextrusion die; and

introducing a polymer comprising polymeric microspheres onto a portion of the major circumferential surface of the rotating tool roll, wherein the portion of the major circumferential surface is in proximity of the die lip, and wherein the polymer foams to provide the coextruded polymeric layer.

In another aspect, the present disclosure provides a fourth method for making a coextruded polymeric layer described herein, the method comprising:

providing a rotating tool roll having a major circumferential surface;

providing a coextrusion die with a die lip spaced in proximity of the rotating tool roll to form a gap between the rotating tool roll and the coextrusion die;

providing a compression roll in proximity of the rotating tool roll to form a gap between the rotating tool roll and the compression roll;

injecting oil into a polymer comprising at least one of a foaming agent, a gas, or polymeric microspheres in an extrusion chamber; and

extruding the polymer into the gap between the coextrusion die and the rotating tool roll, wherein the polymer foams to provide the coextruded polymeric layer.

In another aspect, the present disclosure provides a fifth method for making a coextruded polymeric layer described herein, the method comprising:

providing a rotating tool roll having a major circumferential surface and a coextrusion die with a die lip spaced in proximity of the rotating tool roll to form a gap between the rotating tool roll and the coextrusion die; and

introducing reactive polymer onto a portion of the major circumferential surface of the rotating tool roll, wherein the portion of the major circumferential surface is in proximity of the die lip and wherein the reactive polymer foams and at least partially polymerizes to provide the coextruded polymeric layer.

In another aspect, the present disclosure provides a sixth method for making a coextruded polymeric layer described herein, the method comprising:

providing a rotating tool roll having a major circumferential surface and a coextrusion die with a die lip spaced in proximity of the rotating tool roll to form a gap between the rotating tool roll and the coextrusion die;

providing an extruder connected to the coextrusion die;

introducing a reactive monomer into the extruder, wherein the reactive monomer at least partially polymerizes in the extruder and coextrusion die to form a polymer; and

injecting the polymer from the coextrusion die onto a portion of the major circumferential surface of the rotating tool roll, wherein a portion of the major circumferential surface is in proximity of the die lip and wherein the polymer foams to provide the coextruded polymeric layer.

Coextruded polymeric layers described herein are useful, for example, in vibration damping applications (e.g., a vibration damping laminate comprising a kinetic spacer comprising coextruded polymeric layers described herein).

### BRIEF DESCRIPTION OF THE DRAWINGS

FIGS. 1 and 2 are cross sectional views of an exemplary coextruded polymeric layers described herein.

FIGS. 3-8 are exemplary apparatuses for making exemplary coextruded polymeric layers described herein.

FIGS. 9-12 are cross sectional views of exemplary coextruded polymeric layer described herein.

FIG. 13 is a three-dimensional view of shim die described herein.

FIG. 14 is a front view of shim die orifices described herein.

FIG. 15 is a cross sectional view of an exemplary coextruded polymeric layer described herein.

FIG. 16 is a top view of an exemplary coextruded polymeric layer described herein.

### DETAILED DESCRIPTION

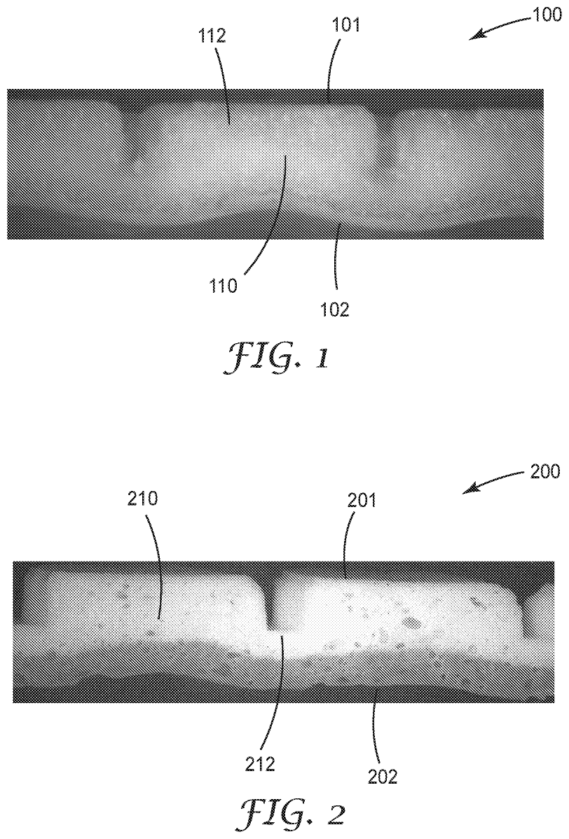

Referring to FIG. 1, coextruded polymeric layer 100 has first and second opposed major surfaces 101, 102. Coextruded polymeric layer 100 has foam 110 and features 112 extending from first major surface 101 by at least 100 micrometers. First major surface 101 has a first material having a first percent elongation at break. Second major surface 102 has a second material having a second percent elongation at break. The first percent elongation at break is greater than 100 percent of the second percent elongation at break.

Referring to FIG. 2, coextruded polymeric layer 200 has first and second opposed major surfaces 201, 202. Coextruded polymeric layer 200 has foam 210 and features 212 extending into first major surface 201 by at least 100 micrometers. First major surface 201 has a first material having a first percent elongation at break. Second major surface 202 has a second material having a second percent elongation at break. The first percent elongation at break is greater than 100 percent of the second percent elongation at break.

In some embodiments, the polymeric material comprises at least one of polycarbonate, a polyacrylic, a polymethacrylic, an elastomer, a styrenic block copolymer, a styrene-isoprene-styrene (SIS), a styrene-ethylene/butylene-styrene block copolymer (SEBS), a polybutadiene, a polyisoprene, polychloroprene, a random copolymer of styrene and diene styrene-butadiene rubber (SBR), a block copolymer of styrene and diene styrene-butadiene rubber (SBR), an ethylene-propylene-diene monomer rubber, a natural rubber, an ethylene propylene rubber, a polyethylene-terephthalate (PET), a polystyrene-polyethylene copolymer, a polyvinylcyclohexane, a polyacrylonitrile, a polyvinyl chloride, a thermoplastic polyurethane, an aromatic epoxy, an amorphous polyester, an amorphous polyamides, a semicrystalline polyamide, an acrylonitrile-butadiene-styrene (ABS) copolymer, a polyphenylene oxide alloy, a high impact polystyrene, a polystyrene copolymer, a polymethylmethacrylate (PMMA), a fluorinated elastomer, a polydimethyl siloxane, a polyetherimide, an amorphous fluompolymer, an amorphous polyolefin, a polyphenylene oxide, or a polyphenylene oxide-polystyrene alloy.

In some embodiments, coextruded polymeric layer described herein, comprise at least one copolymer comprising at least one amorphous component. In some embodiments, coextruded polymeric layers described herein, wherein the thermoplastic is an amorphous or semi-crystalline polymer or copolymer. In some embodiments, coextruded polymeric layers described herein, comprise a star polymer. Exemplary star polymers include at least one of styrene isoprene styrene (SIS), styrene ethylene propylene styrene (SEPS), styrene ethylene butadiene styrene (SEBS), or styrene butadiene styrene (SBS) (including mixtures thereof). Suitable star polymers are available, for example, under the trade designation “KRATON” from Kraton, Houston, Tex.

In some embodiments, a coextruded polymeric layer described herein comprise first and second layers each having first and second major surfaces, wherein the first major surface of the coextruded polymeric layer is the first major surface of a first layer, and wherein the second major surface of the coextruded polymeric layer is the second major surface of a second layer.

In some embodiments of a coextruded polymeric layer described herein comprise first and second layers, the first layer comprise at least one copolymer comprising at least one amorphous component. In some embodiments, coextruded polymeric layers described herein, wherein the thermoplastic is an amorphous or semi-crystalline polymer or copolymer. In some embodiments, coextruded polymeric layers described herein, comprise a star polymer. Exemplary star polymers include at least one of styrene isoprene styrene (SIS), styrene ethylene propylene styrene (SEPS), styrene ethylene butadiene styrene (SEBS), or styrene butadiene styrene (SBS) (including mixtures thereof). Suitable star polymers are available, for example, under the trade designation “KRATON.”

In some embodiments of coextruded polymeric layer described herein comprising first and second layers the second layer comprises at least one of an open mesh or a nonwoven. Exemplary open mesh and nonwoven include open mesh woven material such as a cheesecloth or a spunbond polyethylene-terephthalate (PET) nonwoven. In some embodiments, at least one of the open mesh or a nonwoven has an open area at least partially filled with polymeric material. Exemplary open mesh is available, for example, under the trade designation “CHEESECLOTH 40” from Cheesecloth US, Chicago, Ill. Exemplary nonwoven is available, for example, under the trade designation “LUTRADUR LD-7240” from Freudenberg, Durham, N.C.

In some embodiments of coextruded polymeric layer described herein comprising first and second layers, the second layer comprises at least one of an elastomer, a styrenic block copolymer, a styrene-isoprene-styrene (SIS), a styrene-ethylene/butylene-styrene block copolymer (SEBS), a polybutadiene, a polyisoprene, a polychloroprene, a random copolymer of styrene and diene styrene-butadiene rubber (SBR), a block copolymer of styrene and diene styrene-butadiene rubber (SBR), an ethylene-propylene-diene monomer rubber, a natural rubber, a polyurethane, or an ethylene propylene rubber.

In some embodiments of coextruded polymeric layer described herein comprising first and second layers, the second layer comprises at least one of polypropylene, polyethylene, polyolefin, a polycarbonate, a polyacrylic, a polymethacrylica polyethylene-terephthalate (PET), a polystyrene-polyethylene copolymer, a polyvinylcyclohexane, a polyacrylonitrile, a polyvinyl chloride, a thermoplastic polyurethane, an aromatic epoxy, an amorphous polyester, an amorphous polyamides, a semicrystalline polyamide, an acrylonitrile-butadiene-styrene (ABS) copolymer, a polyphenylene oxide alloy, a high impact polystyrene, a polystyrene copolymer, a polymethylmethacrylate (PMMA), a fluorinated elastomer, a polydimethyl siloxane, a polyetherimide, an amorphous fluoropolymer, an amorphous polyolefin, a polyphenylene oxide, or a polyphenylene oxide-polystyrene alloy.

In some embodiments, coextruded polymeric layer described herein have a glass transition temperature, T_{g}, in a range from −125° C. to 150° C. (in some embodiments, in a range from −125° C. to −10° C., −10° C. to 80° C., 50° C. to 150° C. or even 50° C. to 80° C.). The glass transition temperature is determined as follows, using a differential scanning calorimeter (DSC) available under the trade designation “Q2000 DSC” from TA Instruments, New Castle, Del. The DSC procedure is as follows: cool sample to −180° C., temperature ramp at 10° C./min. to 300° C. The glass transition temperature is recorded as the inflection point in the heat flow versus temperature curve.

In some embodiments, coextruded polymeric layers described herein comprise a material (e.g., a copolymer polypropylene available, for example under the trade designation “C700-35N IMPACT COPOLYMER POLYPROPYLENE” from Dow Chemical, Midland, Mich.) having a melt flow index greater than 0.1 (in some embodiments, greater than 0.2, 0.25, 0.3, 0.4, 0.5, 1, 5, 10, 25, 50, 75, or even greater than 100).

The first percent elongation at break is greater than 100 (in some embodiments, at least 125, 150, or even at least 200) percent of the second percent elongation at break. In some embodiments, the second percent elongation at break is not greater than 100 (in some embodiments, not greater 80, 75, 70, 60, 50, 40, 30, 25, 20, 15, 10, or even not greater 5; in some embodiments, in a range from 0 to 100, 0 to 75, 0 to 50, 0 to 25, 0 to 10, or even 0 to 5) percent. Elongation at break testing can be determined using ASTM D412 (2016), the disclosure of which is incorporated herein by reference. More specifically, testing is conducted using a tensile tester (available under the trade designation “INSTRON” (Model 5500R) from Instron, Norwood, Mass.) with two 30 kilo-newtons max load grips. Three samples are cut in 25.4 micrometer (1 inch) wide by 152.4 micrometers (6 inch) long strips. The length dimension is cut in the down web direction. Each sample is fastened in the grippers and tensile stress with a grip separation rate of 500 micrometers/minute (20 inches/minute) until sample rupture. Samples are tested at 21° C. (70° F.) environment temperature. At rupture, measure and record the elongation. The elongation at break testing is the average of three sample measurements.

In some embodiments of coextruded polymeric layer described herein comprising first and second layers, the first layer is foamed. In some embodiments of coextruded polymeric layer described herein comprising first and second layers, both the first and second layers are foamed.

In some embodiments, coextruded polymeric layers described herein have a foam portion comprising pores each having an average cell size (i.e., pore size), wherein there is an average cell size for the pores present in the coextruded polymeric layer, and wherein the average cell size of any single cell is within ±1 (in some embodiments, within ±5, ±10, ±25, ±50, ±75, ±100, ±200, ±300, ±400, or even within ±500) micrometer of the cell pore size for the pores present in the coextruded polymeric layer. Pore sizes can be determined an optical microscope (available under the trade designation KEYENCE DIGITAL MICROSCOPE VHX2000″ from Keyence Corporation, Itasca, Ill.) with a 20-200 magnification lens at 100× magnification. Samples are cut 12.7 micrometers (0.50 inch) wide by 38.1 micrometers (1.50 inch) long. The width dimension of the sample is cut in the down web direction. A sample is then mounted in a clamping fixture to view the cross section of the material under the microscope. The digital microscope settings are set to provide a diameter measurement. Measure 10 pores, selecting the pores to provide an average population in the sample. The average pore size is an average of 10 measurements.

In some embodiments, coextruded polymeric layers described herein comprise pores each having an average cell size in a range from 10 to 3000 (in some embodiments, in a range from 10 to 1000, 10 to 500, 10 to 200, 10 to 100, or even 10 to 50) micrometers.

Pore sizes can be measured with an optical microscope (available under the trade designation “KEYENCE DIGITAL MICROSCOPE VHX2000” from Keyence Corporation, Itasca, Ill.) with a 20-200 magnification lens at 100× magnification. Samples are cut 12.7 micrometers (0.50 inch) wide by 38.1 micrometers (1.50 inch) long. The width dimension of the sample is cut in the down web direction. A sample is then mounted in a clamping fixture to view the cross section of the material under the microscope. The digital microscope settings are set to provide a diameter measurement. Measure 10 pores, selecting the pores to provide an average population in the sample. The average pore size is an average of 10 measurements.

In some embodiments, coextruded polymeric layers described herein have a thickness from the first to the second major surface of the coextruded polymeric layer, wherein there is a gradient of average pore sizes that increase toward the second major surface.

In some embodiments, coextruded polymeric layers described herein, wherein the first and second opposed major surfaces are free of exposed internal porous cells (i.e., less than 10 percent of the surface area of each of the first and second major surface has any exposed porous cells).

In some embodiments, coextruded polymeric layers described herein, wherein at least 40 (in some embodiments, at least 55, 60, 65, 70, 75, 80, 85, 90, 95, 96, 97, 98, 99, or even 100) percent by area of each major surface has an as-cured surface.

In some embodiments, the first major surface has a Shore A value not greater than 100 (in some embodiments, at least 80, or even not greater than 80; in some embodiments, in a range from 0.1 to 100, 1 to 100, 1 to 75, 10 to 75, or even 10 to 50). In some embodiments, the first major surface has a Shore A value of at least 1 (in some embodiments, at least 5, 10, 20, 25, or even at least 50). In some embodiments, the first major surface of the coextruded polymeric layer has a Shore A value in a range from 1 to 100 (in some embodiments, in a range from 10 to 90, 20 to 80, 30 to 80, 40 to 80, 50 to 80, or even 60 to 70). The Shore A value of polymeric foam is determined using a Shore A durometer scale digital hardness tester available under the trade designation “SHORE D/SHORE A DUROMETER SCALE DIGITAL HARDNESS TESTER” from Zwick/Roell, Kennesaw, Ga. The hardness is determined by gently compressing the instrument into the foam, being careful not to deform the surface of the foam.

In some embodiments, coextruded polymeric layers described herein have a thickness from the first to the second major surface, wherein there is a gradient of a Shore A values through the thickness from the first to the second major surface.

In some embodiments, the first major surface has a Shore 00 value of at least 10 (in some embodiments, at least 15, 20, 25, 30, 35, 40, or even at least 50; in some embodiments, in a range from 10 to 80, 10 to 70, 10 to 60, or even 10 to 50). The Shore 00 value of polymeric foam is determined using a Shore 00 durometer scale digital hardness tester available under the trade designation “ZWICKROELL 3111” from Zwick/Roell.

In some embodiments, the second major surface has a Shore D value of at least 10 (in some embodiments, at least 15, 20, 25, 30, 40, 50, 60, 70, 80, 90, or even at least 100). In some embodiments, the second major surface has a Shore D value not greater than 100 (in some embodiments, not greater than 90, 80, 75, 70, 60, 50, 40, 30, 25, 20, or even not greater than 10; in some embodiments, in a range from 10 to 100, or 10 to 75, even 10 to 50). The Shore D value of polymeric foam is determined using a Shore D durometer scale digital hardness tester available under the trade designation “SHORE D/SHORE A DUROMETER SCALE DIGITAL HARDNESS TESTER” from Zwick/Roell.

In some embodiments, coextruded polymeric layers described herein have a thickness up to 25,400 (in some embodiments, in a range from 100 to 1000, 1000 to 6000, 6000 to 12,700 or even 12,700 to 25,400) micrometers.

In some embodiments, coextruded polymeric layers described herein have first and second opposed major surfaces, wherein the first and second opposed major surfaces are free of exposed internal porous cells (i.e., less than 10 percent of the surface area of each of the first and second major surface has any exposed porous cells).

In some embodiments, coextruded polymeric layers described herein have a compressive stress versus compressive strain value of at least 1 (in some embodiments, at least 5, 10, 100, 1000, or even 6000; in some embodiments, in a range from 1 to 50, 50 to 500, or even 500 to 6000) MPa. The compressive stress and compressive strain of polymeric foam is determined using a mechanical testing machine available under the trade designation “UNIVERSAL TESTING SYSTEMS 3300” from Instron, Norwood, Mass. A polymeric foam sample, either circular or square in cross-section, is placed between two rigid metal plates of the mechanical testing machine (“UNIVERSAL TESTING SYSTEMS 3300”). The plates compress the sample at a rate of 0.1 inch/min. (2.54 mm/min.) until 75% compression strain is reached. During testing, a calibrated load cell records the force needed to compress the sample, resulting in a force vs. displacement (or stress vs. strain) graph.

In some embodiments, coextruded polymeric layers described herein have a yield stress of at least 0.01 (in some embodiments, at least 0.1, 0.5, 1, 5, or even 10; in some embodiments, in a range from 0.01 to 0.1, 0.1 to 1, or even at least 1 to 100) MPa. The yield stress is determined by placing a point along the x-axis (strain) at 0.2% strain and then from that point extending a line parallel to the initial linear portion of the stress vs. strain curve. The intersection of these two lines is the yield stress.

In some embodiments, coextruded polymeric layers described herein have a durometer value less than 20 (in some embodiments, less than 15, 10, or even less than 5; in some embodiments in a range from 1 to 5, 1 to 10, or even 1 to 15). The durometer value of polymeric foam is determined using a Shore D/Shore A durometer scale digital hardness tester available under the trade designation “SHORE D/SHORE A DUROMETER SCALE DIGITAL HARDNESS TESTER” from Zwick/Roell. The hardness is determined by gently compressing the instrument into the foam, being careful not to deform the surface of the foam.

In some embodiments, coextruded polymeric layers described herein can be wrapped around a 1 m (in some embodiments, 75 cm, 50 cm, 25 cm, 10 cm, 5 cm, 1 cm, 5 mm, or even 1 mm) diameter rod without breaking.

In some embodiments, the features comprise at least one of the following shapes: a cone, a cube, a pyramid, a continuous rail, continuous multi-directional rails, a hemisphere, a cylinder, or a multi-lobed cylinder. In some embodiments, the features have a cross-section in at least one of the following shapes: circle, square, rectangle, triangle, pentagon, other polygon, sinusoidal, herringbone, or multi-lobe.

In some embodiments, the features have lower compressive strength than the surface from which they extend.

In some embodiments, the features have higher dissipation energy than the surface from which they extend.

In some embodiments, the features have a cross-section area in a range from 2 to 400 (in some embodiments, in a range from 2 to 300, 2 to 200, 2 to 100, 2 to 50, or even 2 to 20) square millimeters.

In some embodiments of coextruded polymeric layers described herein have a total porosity of at least 25 (in some embodiments, at least 30, 35, 40, 45, 50, 55, 60, 65, 70, 75, or even at least 80; in some embodiments, in a range from 25 to 80, 30 to 60, or even 30 to 50) percent, based on the total volume of the coextruded polymeric layer.

In some embodiments of coextruded polymeric layers described herein further comprising a polymer layer on the foam features, wherein the polymer layer comprises polymer different from polymer comprising the coextruded polymeric layer.

In some embodiments of coextruded polymeric layers described herein comprise at least one of glass beads, glass bubbles, glass fibers, abrasive grain, carbon black, carbon fibers, diamond particles, composite particles, nanoparticles, mineral oil, tackifier, wax, rubber particles or flame retardant.

In some embodiments of coextruded polymeric layers described herein comprise a thermal conductive material (e.g., BN).

In some embodiments of coextruded polymeric layers described herein comprise an electrically conductive material such as available, under the trade designation “RTP 1200 S GP90025530” from RTP Company, Winona Minn.

### —First Method

In another aspect, the present disclosure provides a first method for making a coextruded polymeric layer described herein, the method comprising:

providing a rotating tool roll having a major circumferential surface and a coextrusion die with a die lip spaced in proximity of the rotating tool roll to form a gap between the rotating tool roll and the coextrusion die; and

coextruding at least first and second polymers from the coextrusion die onto a portion of the major circumferential surface of the rotating tool roll, wherein at least one of the first or second polymers comprises a forming agent, and wherein the portion of the major circumferential surface is in proximity of the die lip

to provide the coextruded polymeric layer.

In some embodiments, the major circumferential surface of the rotating tool roll comprises an array of cavities. In some embodiments, the major circumferential surface of the compression roll comprises an array of cavities. In some embodiments, the major circumferential surface of the rotating tool roll comprises an array of protrusions. The size and shape of the cavities or protrusions can be as desired. Exemplary shapes may include a cone, a cube, a pyramid, a continuous rail, continuous multi-directional rails, a hemisphere, a cylinder, and a multi-lobed cylinder. Exemplary cross-sections may include a circle, a square, a rectangle, a triangle, a pentagon, other polygon, a sinusoidal, a herringbone, or a multi-lobe. Exemplary sizes may be heights in a range from 100 micrometers to 25,400 micrometers and widths in a range from 100 micrometers to 25,400 micrometers.

In some embodiments of the first method, the foaming agent comprises at least one of an acid (e.g., citric acid), bicarbonate, azodicarbonamide, modified azodicarbonamide, hydrazide, sodium bicarbonate and citric acid blend, dinitrosopentamethylenetetramine, p-toluenesulfonyl hydrazide, 4-4′-oxybis hydrazide, azodicarbonamide, p-toluenesulfonyl semicarbazide, 5-phenyltetrazole, 5-phenyltetrazole analogues, diisopropylhydrazodicarboxylate, 5-phenyl-3,6-dihydro-1,3,4-oxadiazin-2-one, or sodium borohydride.

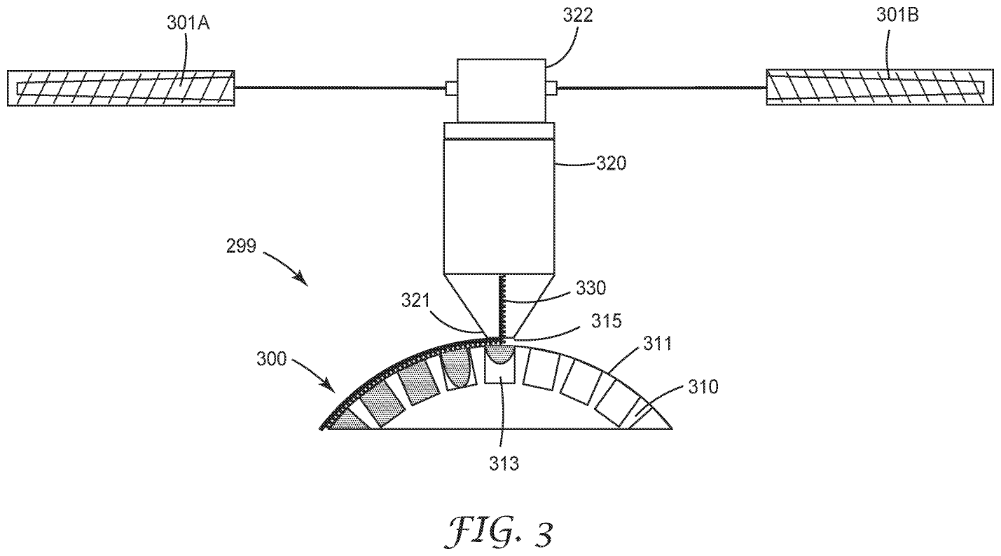

Referring to FIG. 3, apparatus 299 has rotating tool roll 310 with major circumferential surface 311. Feed block 322 attached to the coextrusion die 320 having a die lip 321 spaced in proximity of rotating tool roll 310 providing gap 315 between rotating tool roll 310 and coextrusion die 320. Extruders 301A and 301B feed feed block 322. Polymer 330 with a foaming agent is introduced onto portion 313 of major circumferential surface 311 of rotating tool roll 310. Portion of the major circumferential surface is in proximity of die lip 321 to provide coextruded polymeric layer described herein 300.

### —Second Method

In another aspect, the present disclosure provides a second method for making a coextruded polymeric layer described herein, the method comprising:

providing a rotating tool roll having a major circumferential surface and a coextrusion die with a die lip spaced in proximity of the rotating tool roll to form a gap between the rotating tool roll and the coextrusion die; and

coextruding at least first and second polymers from the coextrusion die onto a portion of the major circumferential surface of the rotating tool roll, wherein the portion of the major circumferential surface is in proximity of the die lip, wherein a gas is injected into at least one of the first or second polymers prior the polymer contacting the portion of the major circumferential surface of the rotating tool roll and, wherein the extruded polymer foams

to provide the coextruded polymeric layer.

In some embodiments, the major circumferential surface of the rotating tool roll comprises an array of cavities. In some embodiments, the major circumferential surface of the rotating tool roll comprises an array of protrusions. The size and shape of the cavities or protrusions can be as desired. Exemplary shapes may include a cone, a cube, a pyramid, a continuous rail, continuous multi-directional rails, a hemisphere, a cylinder, and a multi-lobed cylinder. Exemplary cross-sections may include a circle, a square, a rectangle, a triangle, a pentagon, other polygon, a sinusoidal, a herringbone, or a multi-lobe. Exemplary sizes may be heights in a range from 100 micrometers to 25,400 micrometers and widths in a range from 100 micrometers to 25,400 micrometers.

In some embodiments of the second method, the gas comprises at least one of argon, carbon dioxide, nitrogen, a butane (e.g., n-butane and isobutane), a heptane (e.g., n-heptane, isoheptane, and cycloheptane), a hexane (e.g., n-hexane, neohexane, isohexane, and cyclohexane), an octane (e.g., n-octane and cyclooctane), or a pentane (e.g., n-pentane, cyclopentane, neopentane, and isopentane).

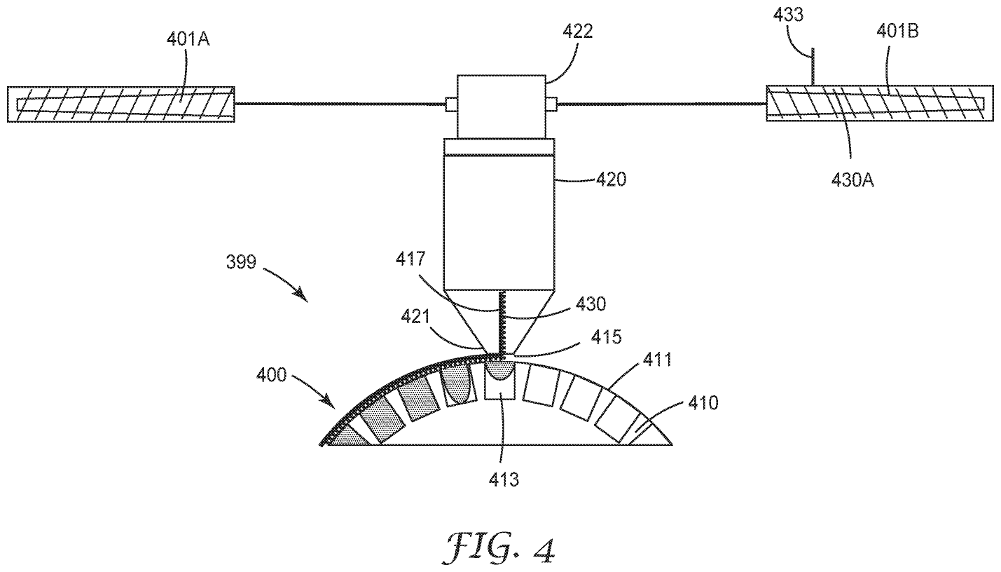

Referring to FIG. 4, apparatus 399 has rotating tool roll 410 with major circumferential surface 411. Feed block 422 attached to the coextrusion die 420 having a die lip 421 spaced in proximity of rotating tool roll 410 providing gap 415 between rotating tool roll 410 and coextrusion die 420. Extruders 401A and 401B feed feed block 422. Polymer 430 with comprising a foaming agent is introduced onto portion 413 of major circumferential surface 411 of rotating tool roll 410. Gas 433 is injected into polymer 430a prior to contact of polymer 417 with portion 413 of major circumferential surface 411 of tool roll 410. Portion 413 of major circumferential surface is in proximity of die lip 421 to provide coextruded polymeric layer described herein 400.

### —Third Method

In another aspect, the present disclosure provides a third method for making a coextruded polymeric layer described herein, the method comprising:

providing a rotating tool roll having a major circumferential surface and a coextrusion die with a die lip spaced in proximity of the rotating tool roll to form a gap between the rotating tool roll and the coextrusion die; and

introducing a polymer comprising polymeric microspheres onto a portion of the major circumferential surface of the rotating tool roll, wherein the portion of the major circumferential surface is in proximity of the die lip, and wherein the polymer foams to provide the coextruded polymeric layer.

In some embodiments, the major circumferential surface of the rotating tool roll comprises an array of cavities. In some embodiments, the major circumferential surface of the rotating tool roll comprises an array of protrusions. The size and shape of the cavities or protrusions can be as desired. Exemplary shapes may include a cone, a cube, a pyramid, a continuous rail, continuous multi-directional rails, a hemisphere, a cylinder, and a multi-lobed cylinder. Exemplary cross-sections may include a circle, a square, a rectangle, a triangle, a pentagon, other polygon, a sinusoidal, a herringbone, or a multi-lobe. Exemplary sizes may be heights in a range from 100 micrometers to 25,400 micrometers and widths in a range from 100 micrometers to 25,400 micrometers.

In some embodiments, the polymeric microspheres comprise expanding bubbles. Exemplary expanding bubbles are available, for example, under the trade designations “EXPANCEL” from AkzoNobel, Amsterdam, Netherlands, or “DUALITE” from Chase Corporation, Westwood, Mass.

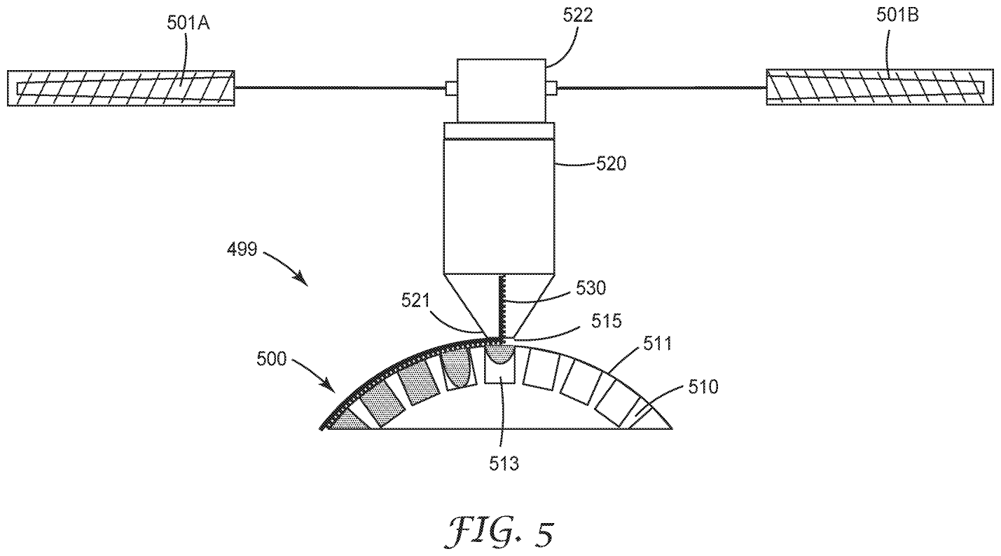

Referring to FIG. 5, apparatus 499 has rotating tool roll 510 with major circumferential surface 511. Feed block 522 attached to the coextrusion die 520 having die lip 521 spaced in proximity of rotating tool roll 510 to provide gap 515 between rotating tool roll 510 and coextrusion die 520. Extruders 501A and 501B feed feed block 522. Polymer 530 with a foaming agent is introduced onto portion 513 of major circumferential surface 511 of rotating tool roll 510. Portion 513 of major circumferential surface 511 is in proximity of die lip 521 to provide coextruded polymeric layer described herein 500.

### —Fourth Method

In another aspect, the present disclosure provides a fourth method for making a coextruded polymeric layer described herein, the method comprising:

providing a rotating tool roll having a major circumferential surface;

providing a coextrusion die with a die lip spaced in proximity of the rotating tool roll to form a gap between the rotating tool roll and the coextrusion die;

providing a compression roll in proximity of the rotating tool roll to form a gap between the rotating tool roll and the compression roll;

injecting oil into a polymer comprising at least one of a foaming agent, a gas, or polymeric microspheres in an extrusion chamber; and

extruding the polymer into the gap between the coextrusion die and the rotating tool roll, wherein the polymer foams

to provide the coextruded polymeric layer.

In some embodiments of the fourth method for making a coextruded polymeric layer described herein, the major circumferential surface of the rotating tool roll comprises an array of cavities. In some embodiments, the major circumferential surface of the rotating tool roll comprises an array of protrusions. In some embodiments, the fourth method further comprises a compression roll having a major circumferential surface positioned near the coextrusion die, down web. In some embodiments, the major circumferential surface of the compression roll comprises an array of cavities. In some embodiments, the major circumferential surface of the compression roll comprises an array of protrusions. The size and shape of the cavities or protrusions can be as desired. Exemplary shapes may include a cone, a cube, a pyramid, a continuous rail, continuous multi-directional rails, a hemisphere, a cylinder, and a multi-lobed cylinder. Exemplary cross-sections may include a circle, a square, a rectangle, a triangle, a pentagon, other polygon, a sinusoidal, a herringbone, or a multi-lobe. Exemplary sizes may be heights in a range from 100 micrometers to 25,400 micrometers and widths in a range from 100 micrometers to 25,400 micrometers.

In some embodiments of the fourth method, the oil comprises at least one of a lanolin, a liquid polyacrylate, a liquid polybutene, a mineral oil, or a phthalate. In some embodiments, the oil is at a temperature greater than 80° C. (in some embodiments, at least 90° C., 100° C., 125° C., 150° C., 175° C., or even, at least 200° C.; in some embodiments, in a range from 80° C. to 250° C., 100° C. to 250° C., or even 100° C. to 200° C.).

In some embodiments of the fourth method, the foaming agent comprises at least one of an acid (e.g., citric acid), a bicarbonate, an azodicarbonamide, a modified azodicarbonamide, a hydrazide, a sodium bicarbonate and citric acid blend, dinitrosopentamethylenetetramine, p-toluenesulfonyl hydrazide, 4-4′-oxybis hydrazide, azodicarbonamide, p-toluenesulfonyl semicarbazide, 5-phenyltetrazole, a 5-phenyltetrazole analogue, diisopropylhydrazodicarboxylate, 5-phenyl-3,6-dihydro-1,3,4-oxadiazin-2-one, or sodium borohydride. In some embodiments of the fourth method, the gas comprises at least one of argon, carbon dioxide, nitrogen, a butane (e.g., n-butane and isobutane), a heptane (e.g., n-heptane, isoheptane, and cycloheptane), a hexane (e.g., n-hexane, neohexane, isohexane, and cyclohexane), an octane (e.g., n-octane and cyclooctane), or a pentane (e.g., n-pentane, cyclopentane, neopentane, and isopentane). In some embodiments of the fourth method, the polymeric microspheres comprise expanding bubbles. Exemplary expanding bubbles are available, for example, under the trade designations “EXPANCEL” from AkzoNobel, Amsterdam, Netherlands, or “DUALITE” from Chase Corporation, Westwood, Mass.

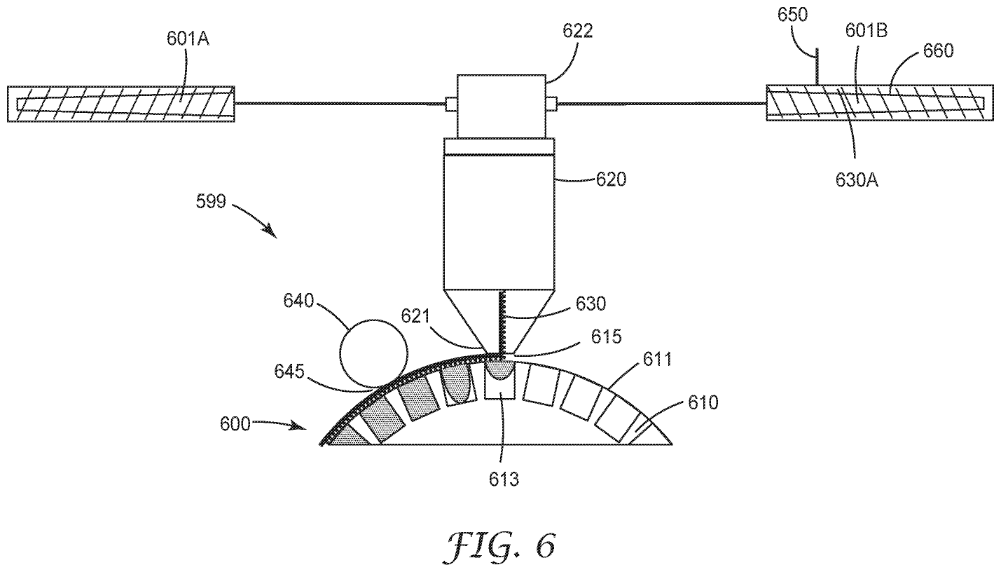

Referring to FIG. 6, apparatus 599 has rotating tool roll 610 with major circumferential surface 611. Feed block 622 attached to the coextrusion die 620 having die lip 621 spaced in proximity of rotating tool roll 610 to provide gap 615 between rotating tool roll 610 and coextrusion die 620. Compression roll 640 in proximity of rotating tool roll 610 provides gap 645 between rotating tool roll 610 and compression roll 640. Oil 650 is injected into polymer 630A with at least one of a foaming agent, a gas, or polymeric microspheres in extrusion chamber 660. Extruders 601A and 601B feed feed block 622. Polymer 630 is extruded into gap 615 between coextrusion die 620 and rotating tool roll 610. Polymer 630 foams to provide coextruded polymeric layer described herein 600.

### —Fifth Method

In another aspect, the present disclosure provides a fifth method for making a coextruded polymeric layer described herein, the method comprising:

providing a rotating tool roll having a major circumferential surface and a coextrusion die with a die lip spaced in proximity of the rotating tool roll to form a gap between the rotating tool roll and the coextrusion die; and

introducing reactive polymer onto a portion of the major circumferential surface of the rotating tool roll, wherein the portion of the major circumferential surface is in proximity of the die lip and wherein the reactive polymer foams and at least partially polymerizes

to provide the coextruded polymeric layer.

In some embodiments, the major circumferential surface of the rotating tool roll comprises an array of cavities. In some embodiments, the major circumferential surface of the rotating tool roll comprises an array of protrusions. In some embodiments, further comprises a compression roll having a major circumferential surface positioned near the coextrusion die, downweb. In some embodiments, the major circumferential surface of the compression roll comprises an array of cavities. In some embodiments, the major circumferential surface of the compression roll comprises an array of protrusions. The size and shape of the cavities or protrusions can be as desired. Exemplary shapes may include a cone, a cube, a pyramid, a continuous rail, continuous multi-directional rails, a hemisphere, a cylinder, and a multi-lobed cylinder. Exemplary cross-sections may include a circle, a square, a rectangle, a triangle, a pentagon, other polygon, a sinusoidal, a herringbone, or a multi-lobe. Exemplary sizes may be heights in a range from 100 micrometers to 25,400 micrometers and widths in a range from 100 micrometers to 25,400 micrometers.

In some embodiments, the reactive polymer reacts after forming to increase the molecular weight of the coextruded polymeric layer. In some embodiments, the reactive polymer reacts to crosslink the coextruded polymeric layer. In some embodiments, the reactive polymer reacts with moisture to cause polymerization or crosslinking of the coextruded polymeric layer. In some embodiments, the reactive polymer comprises isocyanate functional groups, alkoxysilane functional groups, or ketimine functional groups. In some embodiments, the reactive polymer comprises at least one of a (meth)acrylic functional group, an allyl functional group, or a vinyl functional group.

In some embodiments fifth method for making a coextruded polymeric layer described herein includes exposing the reactive polymer to at least one of gamma radiation, E-beam radiation, or UV-radiation to cause at least one of polymerization or crosslinking of the coextruded polymeric layer.

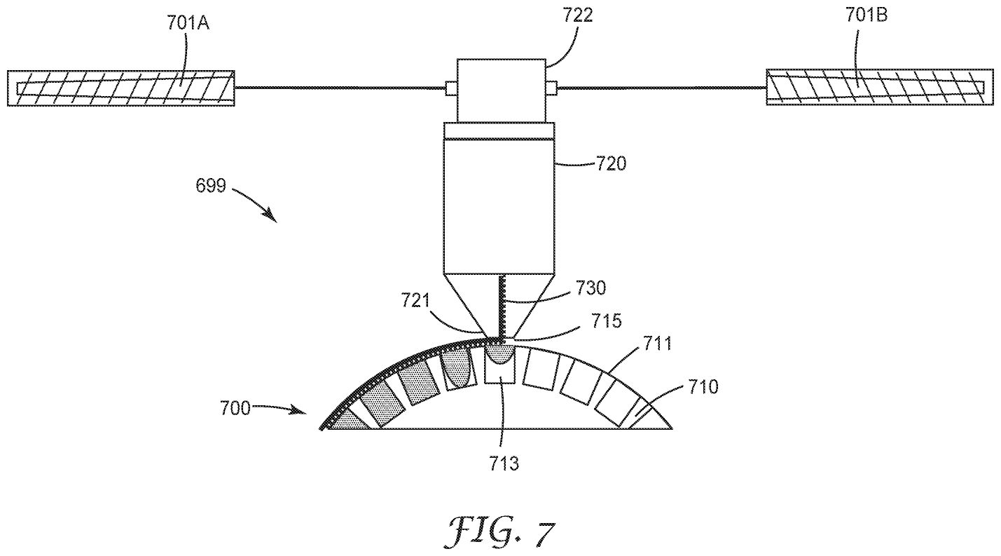

Referring to FIG. 7, apparatus 699 has rotating tool roll 710 with major circumferential surface 711. Feed block 722 attached to the coextrusion die 720 with die lip 721 spaced in proximity of rotating tool roll 710 to provide gap 715 between rotating tool roll 710 and coextrusion die 720. Extruders 701A and 701B feed feed block 722. Reactive polymer 730 is introduced onto portion 713 of major circumferential surface 711 of rotating tool roll 710. Portion 713 of major circumferential surface 711 is in proximity of die lip 721. Reactive polymer 730 foams and at least partially polymerizes to provide coextruded polymeric layer described herein 700.

### —Sixth Method

In another aspect, the present disclosure provides a sixth method for making a coextruded polymeric layer described herein, the method comprising:

providing a rotating tool roll having a major circumferential surface and a coextrusion die with a die lip spaced in proximity of the rotating tool roll to form a gap between the rotating tool roll and the coextrusion die;

providing an extruder connected to the coextrusion die;

introducing a reactive monomer into the extruder, wherein the reactive monomer at least partially polymerizes in the extruder and coextrusion die to form a polymer; and

injecting the polymer from the coextrusion die onto a portion of the major circumferential surface of the rotating tool roll, wherein a portion of the major circumferential surface is in proximity of the die lip and wherein the polymer foams

to provide the coextruded polymeric layer.

In some embodiments, the major circumferential surface of the rotating tool roll comprises an array of cavities. In some embodiments, the major circumferential surface of the rotating tool roll comprises an array of protrusions. In some embodiments, the sixth method further comprises a compression roll having a major circumferential surface positioned near the coextrusion die, downweb. In some embodiments, the major circumferential surface of the compression roll comprises an array of cavities. In some embodiments, the major circumferential surface of the compression roll comprises an array of protrusions. The size and shape of the cavities or protrusions can be as desired. Exemplary shapes may include a cone, a cube, a pyramid, a continuous rail, continuous multi-directional rails, a hemisphere, a cylinder, and a multi-lobed cylinder. Exemplary cross-sections may include a circle, a square, a rectangle, a triangle, a pentagon, other polygon, a sinusoidal, a herringbone, or a multi-lobe. Exemplary sizes may be heights in a range from 100 micrometers to 25,400 micrometers and widths in a range from 100 micrometers to 25,400 micrometers.

In some embodiments, the sixth method for making a coextruded polymeric layer described herein further comprises injecting a reactive polymer into the extruder with the reactive monomer, wherein the monomer has a molecular weight, and wherein the monomer at least partially reacts with the reactive polymer to form a polymer having a higher molecular weight than the molecular weight of the monomer. In some embodiments, the reactive monomer comprises a polyisocyanate and a polyol, and wherein the polymer formed from the reaction of the monomer and the reactive polyisocyanate is a polyurethane. In some embodiments, the reactive monomer further comprises a hydroxyl-functional chain extender. In some embodiments, the ratio by number of isocyanate equivalents to hydroxyl equivalents is in a range from 0.85:1 to 1.2:1 (in some embodiments, in a range from 0.95:1 to 1.05:1 0.95:1 to 1.0:1, or 1.0:1 to 1.06:1). In some embodiments, at least one of the polyol or the polyisocyanate has an average functionality of greater than 2.0.

In some embodiments of the sixth method, the polymer comprises a foaming agent. In some embodiments, the foaming agent comprises at least one of an acid (e.g., citric acid), bicarbonate, azodicarbonamide, modified azodicarbonamide, hydrazide, sodium bicarbonate and citric acid blend, dinitrosopentamethylenetetramine, p-toluenesulfonyl hydrazide, hydrazide, azodicarbonamide, p-toluenesulfonyl semicarbazide, 5-phenyltetrazole, 5-phenyltetrazole analogues, diisopropylhydrazodicarboxylate, 5-phenyl-3,6-dihydro-1,3,4-oxadiazin-2-one, or sodium borohydride. In some embodiments of the sixth method the foaming agent comprises polymer microspheres. In some embodiments of the sixth method, the polymer microspheres are expandable bubbles. Exemplary expanding bubbles are available, for example, under the trade designations “EXPANCEL” from AkzoNobel, Amsterdam, Netherlands, or “DUALITE” from Chase Corporation, Westwood, Mass.

In some embodiments, the foaming agent comprises water and isocyanate. In some embodiments, the foaming agent comprises a gas comprising at least one of argon, carbon dioxide, nitrogen, a butane (e.g., n-butane and isobutane), a heptane (e.g., n-heptane, isoheptane, and cycloheptane), a hexane (e.g., n-hexane, neohexane, isohexane, and cyclohexane), an octane (e.g., n-octane and cyclooctane), or a pentane (e.g., n-pentane, cyclopentane, neopentane, and isopentane).

Referring to FIG. 8, apparatus 799 has rotating tool roll 810 with major circumferential surface 811. Feed block 822 attached to the coextrusion die 820 with die lip 821 spaced in proximity of rotating tool roll 819 to provide gap 815 between rotating tool roll 810 and coextrusion die 820. Extruder 819 is connected to coextrusion die 820. Reactive monomer 829 is introduced into extruder 819. Reactive monomer 829 at least partially polymerizes in extruder 819 and coextrusion die 820 to provide polymer 830. Extruders 801A and 801B feed feed block 822. Polymer 830 is injected from coextrusion die 820 onto portion 813 of major circumferential surface 811 of rotating tool roll 810. Portion 813 of major circumferential surface 811 is in proximity of die lip 821 and polymer 830 foams to provide coextruded polymeric layer described herein 800.

The apparatus can be made of conventional materials and techniques known in the art for apparatuses of these general types.

Exemplary uses of coextruded polymeric layers described herein include vibration damping and polishing applications (e.g., polishing pads useful in chemical mechanical planarization (CMP)).

Further to CMP polishing applications, the polishing pad thickness may coincide with the required thickness to enable polishing on the appropriate polishing tool. In some embodiments, the polishing pad thickness is greater than 125 (in some embodiments, greater than 150, 200 or even greater than 500; in some embodiments, less than 40,000, 30,000, 20,000, 15,000, 10,000, 5,000 or even less than 2,500) micrometers. The polishing pad may be in any of a variety of shapes (e.g., circular, square, or hexagonal). The pads may be fabricated such that the pad shape coincides with the shape of the corresponding platen of the polishing tool the pad will be attached to during use. The maximum dimension of the pad (e.g., the diameter for a circular shaped pad) can be as desired for a particular application. In some embodiments, the maximum dimension of a pad is at least 10 cm (in some embodiments, at least 20 cm, 25 cm, 30 cm, 40 cm, 50 cm, or even, at least 60 cm; in some embodiments, less than 2 meters, 1.5 meter, or even less than 1 meter).

In some polishing pad embodiments, the foam features extend from or into the first major surface by at least 100 micrometers (in some embodiments, at least 200 micrometers or even at least 300 micrometers; in some embodiments, up to 20,000 micrometers, 15,000 micrometers, 10,000 micrometers or even up to 5,000 micrometers).

The coextruded polymeric layer of the polishing pad may further include at least one channel, wherein the channel has a depth greater than the distance the foam features extend from or into the first major surface. In some embodiments, the coextruded polymeric layer of the polishing pad may further include at least a plurality of channels, wherein at least a portion of the plurality of channels has a depth greater than the distance the foam features extend from or into the first major surface. The at least one channel may provide improved polishing solution distribution, coextruded polymeric layer flexibility, as well as facilitate swarf removal from the polishing pad. In some embodiments, the channels do not allow fluid to be contained indefinitely within the channel (i.e., fluid can flow out of the channel during use of the pad).

In some embodiments, the width of the at least one channel is at least 10 (in some embodiments, at least 25, 50, 75, or even at least 100; in some embodiments less than 20,000, 10,000, 5,000, 2,000, 1,000, 500, or even less than 200) micrometers. In some embodiments, the depth of the at least one channel is at least 125 (in some embodiments, at least 200, 300, 400, 500, 600, 700, 800, 900, 1,000, 1,500, or even at least 2,000; in some embodiments, less than 25,000, 20,000, 15,000, 10,000, 8,000, 5,000, 3,000, or even less than 1,000) micrometers.

The channels may be formed into the polishing layer by any known techniques in the art including, but not limited to, machining, embossing and molding. The channels may be formed during the formation of the coextruded polymeric layer and/or by the same process used to form the coextruded polymeric layer. Due to improved surface finish on the first major surface of the polishing layer (which helps minimize substrate defects (e.g., scratches during use)), embossing and molding may be preferred. In some embodiments, the channels extending from or into the first major surface of the coextruded polymeric layer are fabricated in the molding process used to form the foam features. This is achieved by forming their negative (i.e., raised regions) in the tool roll, with the channels themselves then being formed in the coextruded polymeric layer during molding. This is of particular advantage, as the foam features extending from or into the first major surface of the coextruded polymeric layer and the at least one channel may be fabricated into the polishing layer in a single process step, leading to cost and time savings. The channels can be fabricated to form various patterns known in the art (e.g., concentric rings, parallel lines, radial lines, a series of lines forming a grid array, herring bone, and spiral). Combinations of differing patterns may be used.

In yet another embodiment, the polishing pad of the present disclosure may include a subpad, wherein the subpad is adjacent to the second major surface of the polymeric foam layer. The polishing pad layers (e.g., coextruded polymeric layer and subpad, may be adhered together by any techniques known in the art (including using adhesives (e.g., pressure sensitive adhesives (PSAs), hot melt adhesives and cure in place adhesives)). In some embodiments, the polishing pad includes an adhesive layer adjacent to the second major surface of the coextruded polymeric layer. Use of a lamination process in conjunction with PSAs (e.g., PSA transfer tapes) is one particular process for adhering the polishing pad and subpad. The subpad may be any of those known in the art. The subpad may be a single layer of a substantially rigid material (e.g., polycarbonate) or a single layer of a substantially compressible material (e.g., an elastomeric foam). The subpad may also have at least two layers, and may include a substantially rigid layer (e.g., a stiff material or high modulus material (e.g., polycarbonate or polyester)) and a substantially compliant layer (e.g., an elastomer or an elastomeric foam material). If the subpad includes a substantially compliant layer (e.g., an elastomeric layer, the compliant layer may have a durometer in a range from 20 Shore D to 90 Shore D). In some embodiments, the compliant layer has a thickness in a range from 125 to 5,000 (in some embodiments, in a range from 125 to 1000) micrometers.

In some embodiments of polishing pads that include a subpad having at least one opaque layer, a small (e.g., 1 cm to 5 cm) hole may be cut into the subpad creating a “window”. The hole may be cut through the entire subpad or only through at least one opaque layer. The cut portion of the subpad or at least one opaque layer is removed from the subpad, allowing light to be transmitted through this region. The hole is pre-positioned to align with the endpoint window of the polishing tool platen and facilitates the use of the wafer endpoint detection system of the polishing tool, by enabling light from the tool's endpoint detection system to travel through the polishing pad and contact the wafer. Light-based endpoint polishing detection systems are known in the art and are available, for example, under the trade designations “MIRRA” and “REFLEXION LK CMP” from Applied Materials, Inc., Santa Clara, Calif. Polishing pads described herein can be fabricated to run on such tools and endpoint detection windows, which are configured to function with the polishing tool's endpoint detection system, can be included in the polishing pad.

In some embodiments, a polishing pad described herein includes subpad laminated thereto. The subpad can include at least one rigid layer (e.g., polycarbonate) and at least one compliant layer (e.g., an elastomeric foam, the elastic modulus of the rigid layer being greater than the elastic modulus of the compliant layer). The rigid layer may be laminated to the second major surface of the coextruded polymeric layer, typically through the use of a PSA (e.g., transfer adhesive or tape). The compliant layer may be opaque and prevent light transmission required for endpoint detection. Prior to, or after lamination, a hole (e.g., up to 5 cm wide by 20 cm long) may be die cut, for example, by a standard kiss cutting method or cut by hand, in the opaque compliant layer of the subpad. The cut region of the compliant layer is removed creating a “window” in the polishing pad. If adhesive residue is present in the hole, it can be removed, for example, through the use, for example, of an appropriate solvent and/or wiping with a cloth. The “window” in the polishing pad is configured such that, when the polishing pad is mounted to the polishing tool platen, the window of the polishing pad aligns with the endpoint detection window of the polishing tool platen. The dimensions of the hole are generally the same or similar in dimension to the dimensions of the endpoint detection window of the platen.

The polishing pad, including any one of coextruded polymeric layers, the subpad and any combination thereof, may include a window (i.e., a region allowing light to pass through) to enable standard endpoint detection techniques used in polishing processes (e.g. wafer endpoint detection).

The present disclosure also describes a polishing system comprising at least one polishing pad and at least one polishing solution. Suitable polishing solutions are known in the art. The polishing solutions may be aqueous or non-aqueous. An aqueous polishing solution has at least 50% by weight water. A non-aqueous solution has less than 50% by weight water. In some embodiments, the polishing solution is a slurry (i.e., a liquid that contains organic and/or inorganic abrasive particles). The concentration of organic and/or inorganic abrasive particles in the polishing solution is as desired. In some embodiments, the concentration of organic and/or inorganic abrasive particles in the polishing solution is at least 0.5% (in some embodiments, at least 1%, 2%, 3%, 4%, or even at least 5%; in some embodiments, less than 30%, 20%, 15%, or even less than 10%) by weight. In some embodiments, the polishing solution is substantially free of organic and/or inorganic abrasive particles. By “substantially free of organic or inorganic abrasive particles,” it is meant that the polishing solution contains not greater than 0.5% (in some embodiments, not greater than 0.25%, 0.1%, or even not greater than 0.05%) by weight of organic and/or inorganic abrasive particles. In some embodiments, the polishing solution contain no organic and no inorganic abrasive particles. The polishing system may include polishing solutions (e.g., slurries), used for silicon oxide CMP (e.g., shallow trench isolation CMP), metal CMP (e.g., tungsten CMP, copper CMP, and aluminum CMP), barrier CMP (e.g., tantalum and tantalum nitride CMP), and hard substrates (e.g., sapphire). In some embodiments, the polishing system further comprises a substrate to be polished or abraded.

The present disclosure also describes a method of polishing a substrate, the method comprising:

providing a polishing pad described herein having a working surface;

providing a substrate having a first surface;

contacting the first working surface of the polishing pad with the first substrate surface; and

moving the polishing pad and the substrate relative to one another while maintaining contact between the working surface of the polishing pad and the first substrate surface,

wherein polishing is conducted in the presence of a polishing solution.

In some embodiments, the polishing solution is a slurry as previously described herein. In some embodiments, the substrate is a semiconductor wafer. Exemplary semiconductor wafers comprise at least one of a dielectric material, an electrically conductive material, a barrier and/or adhesion material or a cap material. Exemplary dielectric materials include an inorganic dielectric material (e.g., glass (e.g., silica glasses)) or an organic dielectric material. Exemplary electrically conductive materials include metals (e.g., at least one of copper, tungsten, aluminum, or silver). Exemplary cap materials include at least one of silicon carbide or silicon nitride. Exemplary barrier and/or adhesion materials include at least one of tantalum or tantalum nitride. The method of polishing may also include a pad conditioning or cleaning step, which may be conducted in-situ (i.e., during polishing). Pad conditioning may use any pad conditioner (e.g., a diamond pad conditioner), or brush known in the art and is available, for example, under the trade designations “3M CMP PAD CONDITIONER BRUSH PB33A” from the 3M Company, St. Paul, Minn., and/or a water or solvent rinse of the polishing pad.

Kinetic spacer layers found in damping laminates are effective in improving the damping performance of a dissipative layer. Minimizing weight is a major need in many industries, especially transportation. Through a foamed kinetic spacer of the coextruded polymeric layer described herein, reductions in both weight and complexity of manufacturing are achievable. While rigid foams can be machined to have spacer elements, minimizing the inherent waste and extra processing steps greatly simplifies the production of such structures.

The engine, drive train and other portions of a vehicle (e.g., automobiles, airplanes, and motorboats) can generate mechanical vibrations that propagate through the body of the vehicle as structure borne noise. Such structure born noise can transform into air borne noise. It can be useful to damp these structural vibrations before their kinetic energy is radiated as air borne noise into other vehicle areas (e.g., inside a passenger compartment).

Typically, viscoelastic materials such as bitumen or sprayed plastic masses (i.e., single layer damping material) are coated or otherwise applied onto, for example, the surface of a body panel of a vehicle for damping these structural vibrations. The deformation of the body panel and attached viscoelastic layer can lead to stretching and/or compressing of the polymer chains within the viscoelastic material, resulting in the dissipation of mechanical energy in the form of, for example, structural borne vibration (e.g., from the engine, tire/road interactions, compressors, and fans) and the damping of vibrations.

Better damping performance can be achieved by adding a second layer to the damping material, a constraining layer (constrained layer damping (CLD)). The constraining layer is selected such that it is not as elastic as the viscoelastic material layer and may be attached on top of the viscoelastic material layer or dissipating layer opposite of the panel to be damped. The constraining layer may be made, for example, out of aluminum. When the constraining layer is attached on top of the viscoelastic material layer, each deformation of the panel leads not only to stretching and compressing of the polymer chains within the dissipating layer but also to shear within the dissipating layer. Thus, the damping material with an additional constraining layer is more effective than the damping material with only the dissipating layer.

The materials used for constraining layer add weight to the damping material which tends to be undesirable when used, for example, in a vehicle. Such materials also add bending stiffness to the damping material, which may lead to challenges, when applying the CLD material to complex shaped structures.

The efficiency of damping material can also be enhanced when the deformation of the viscoelastic damping layer or dissipating layer is amplified by a “kinetic spacer” or “stand-off” layer. The stand-off layer is usually arranged between the panel to be damped and the constraining layer, typically with a viscoelastic dissipating layer on one or both sides of it. One way to improve the efficiency is to increase the strain within the dissipating layer(s) by using a kinetic spacer layer.

In some embodiments, the kinetic spacer elements have a height in a range from 0.1 mm to 15 mm. In some embodiments, the base layer has a thickness within a range from zero (no base layer present) up to 3 mm.

In some embodiments, the ratio of the height of the kinetic spacer elements (i.e., in the thickness direction of the kinetic spacer layer) to the height, or thickness, of the base material may be, for example, greater than 1.1:1, (in some embodiments, greater than 1.5:1, 2:1, 3:1, 4:1, 5:1, 10:1, 15:1, or even greater than 20:1). It tends to be desirable for the kinetic spacer elements to have a greater height so that at least one end of each spacer element is embedded in, is bonded to, is in contact with, or is in close proximity to the dissipating layer. Such an arrangement tends to facilitate movement of the spacer, allowing it to interact with the dissipating layer so that energy is dissipated within the multilayer material. It can be desirable for each kinetic spacer element to have a height/width aspect ratio in a range from 0.3:1 to 20:1. In general, the performance of the kinetic spacer layer can decrease as the height/width ratio of the spacer elements increases, performance can increase as the height/width ratio of the spacer elements decreases.

Coextruded polymeric layers described herein are useful, for example, in vibration damping applications (e.g., a vibration damping laminate comprising a kinetic spacer comprising coextruded polymeric layers described herein).

### EXEMPLARY EMBODIMENTS

1A. A coextruded polymeric layer having first and second opposed major surfaces, the coextruded polymeric layer comprising foam and the coextruded polymeric layer comprising features extending from or into the first major surface by at least 100 (in some embodiments, at least 200, 300, 500, 750, 1000, 2500, 5000, 7500, 10,000, or even at least 12,700; in a range from 100 to 1000, 1000 to 6000, 6000 to 12,700 or even 12,700 to 25,400) micrometers, the first major surface comprising a first material having a first percent elongation at break, the second major surface comprising a second material having a second percent elongation at break, wherein the first percent elongation at break is greater than 100 (in some embodiments, at least 125, 150, or even at least 200) percent of the second percent elongation at break.
2A. The coextruded polymeric layer of Exemplary Embodiment 1A has foam portion comprising pores each having an average cell size (i.e., pore size), wherein there is an average cell size for the pores present in the coextruded polymeric layer, and wherein the average cell size of any single cell is within ±1 (in some embodiments, within ±5, ±10, ±25, ±50, ±75, ±100, ±200, ±300, ±400, or even within ±500) micrometer of the cell pore size for the pores present in the coextruded polymeric layer.
3A. The coextruded polymeric layer of any preceding A Exemplary Embodiment, wherein the pores each have an average cell size in a range from 10 to 3000 (in some embodiments, in a range from 10 to 1000, 10 to 500, 10 to 200, 10 to 100, or even 10 to 50) micrometers.
4A. The coextruded polymeric layer of any preceding A Exemplary Embodiment, wherein the second percent elongation at break is not greater than 100 (in some embodiments, not greater 80, 75, 70, 60, 50, 40, 30, 25, 20, 15, 10, or even not greater 5; in some embodiments, in a range from 0 to 100, 0 to 75, 0 to 50, 0 to 25, 0 to 10, or even 0 to 5) percent. 5A. The coextruded polymeric layer of any preceding A Exemplary Embodiment, wherein the polymeric material comprises at least one of polycarbonate, a polyacrylic, a polymethacrylic, an elastomer, a styrenic block copolymer, a styrene-isoprene-styrene (SIS), a styrene-ethylene/butylene-styrene block copolymer (SEBS), a polybutadiene, a polyisoprene, a polychloroprene, a random copolymer of styrene and diene styrene-butadiene rubber (SBR), a block copolymer of styrene and diene styrene-butadiene rubber (SBR), an ethylene-propylene-diene monomer rubber, a natural rubber, an ethylene propylene rubber, a polyethylene-terephthalate (PET), a polystyrene-polyethylene copolymer, a polyvinylcyclohexane, a polyacrylonitrile, a polyvinyl chloride, a thermoplastic polyurethane, an aromatic epoxy, an amorphous polyester, an amorphous polyamides, a semicrystalline polyamide, an acrylonitrile-butadiene-styrene (ABS) copolymer, a polyphenylene oxide alloy, a high impact polystyrene, a polystyrene copolymer, a polymethylmethacrylate (PMMA), a fluorinated elastomer, a polydimethyl siloxane, a polyetherimide, an amorphous fluoropolymer, an amorphous polyolefin, polyphenylene oxide, or a polyphenylene oxide-polystyrene alloy.
6A. The coextruded polymeric layer of any preceding A Exemplary Embodiment that is comprised of first and second layers each having first and second major surfaces, wherein the first major surface of the coextruded polymeric layer is the first major surface of a first layer, and wherein the second major surface of the coextruded polymeric layer is the second major surface of a second layer.
7A. The coextruded polymeric layer of Exemplary Embodiment 6A, wherein the second layer comprises at least one of an open mesh or a nonwoven.
8A. The coextruded polymeric layer of Exemplary Embodiment 7A, wherein the at least one of an open mesh or a nonwoven having an open area at least partially filled with a polymeric material.
9A. The coextruded polymeric layer of any of Exemplary Embodiments 6A to 8A, wherein the first layer comprises at least one of an elastomer, a styrenic block copolymer, a styrene-isoprene-styrene (SIS), a styrene-ethylene/butylene-styrene block copolymer (SEBS), a polybutadiene, a polyisoprene, polychloroprene, a random copolymer of styrene and diene styrene-butadiene rubber (SBR), a block copolymer of styrene and diene styrene-butadiene rubber (SBR), an ethylene-propylene-diene monomer rubber, a natural rubber, a polyurethane, or an ethylene propylene rubber.
10A. The coextruded polymeric layer of Exemplary Embodiment any of Exemplary Embodiments 6A to 9A, wherein the second layer comprises at least one of polypropylene, polyethylene, polyolefin, a polycarbonate, a polyacrylic, a polymethacrylica polyethylene-terephthalate (PET), a polystyrene-polyethylene copolymer, a polyvinylcyclohexane, a polyacrylonitrile, a polyvinyl chloride, a thermoplastic polyurethane, an aromatic epoxy, an amorphous polyester, an amorphous polyamides, a semicrystalline polyimide, an acrylonitrile-butadiene-styrene (ABS) copolymer, a polyphenylene oxide alloy, a high impact polystyrene, a polystyrene copolymer, a polymethylmethacrylate (PMMA), a fluorinated elastomer, a polydimethyl siloxane, a polyetherimide, an amorphous fluompolymer, an amorphous polyolefin, a polyphenylene oxide, or a polyphenylene oxide-polystyrene alloy.
11A. The coextruded polymeric layer of Exemplary Embodiment 10A, wherein the second major surface of the coextruded polymeric layer is bonded to the first major surface of the second layer.
12A. The coextruded polymeric layer of any of Exemplary Embodiments 6A to 10A, wherein the second major surface of the coextruded polymeric layer is bonded to the first major surface of the second layer.
13A. The coextruded polymeric layer of any of Exemplary Embodiments 6A to 12A, wherein the first layer is foamed.
14A. The coextruded polymeric layer of any of Exemplary Embodiments 7A to 13A, wherein both the first and second layers are foamed.
15A. The coextruded polymeric layer of any preceding A Exemplary Embodiment, comprising a material having a melt flow index greater than 0.1 (in some embodiments, greater than 0.2, 0.25, 0.3, 0.4, 0.5, 1, 5, 10, 25, 50, 75, or even greater than 100).
16A. The coextruded polymeric layer of any preceding A Exemplary Embodiment, wherein the first major surface has a Shore A value not greater than 100 (in some embodiments, at least 80, or even not greater than 80; in some embodiments, in a range from 0.1 to 100, 1 to 100, 1 to 75, 10 to 75, or even 10 to 50).
17A. The coextruded polymeric layer of any preceding A Exemplary Embodiment, wherein the first major surface has a Shore A value of at least 1 (in some embodiments, at least 5, 10, 20, 25, or even at least 50).
18A. The coextruded polymeric layer of any preceding A Exemplary Embodiment, wherein the first major surface has a Shore 00 value of at least 10 (in some embodiments, at least 15, 20, 25, 30, 35, 40, or even at least 50; in some embodiments, in a range from 10 to 80, 10 to 70, 10 to 60, or even 10 to 50).
19A. The coextruded polymeric layer of any of Exemplary Embodiments 1A to 15A, wherein the first major surface of the coextruded polymeric layer has a Shore A value in a range from 1 to 100 (in some embodiments, in a range from 10 to 90, 20 to 80, 30 to 80, 40 to 80, 50 to 80, or even 60 to 70).
20A. The coextruded polymeric layer of any preceding A Exemplary Embodiment, wherein the second major surface has a Shore D value of at least 10 (in some embodiments, at least 15, 20, 25, 30, 40, 50, 60, 70, 80, 90, or even at least 100).
21A. The coextruded polymeric layer of any preceding A Exemplary Embodiment, wherein the second major surface has a Shore D value not greater than 100 (in some embodiments, not greater than 90, 80, 75, 70, 60, 50, 40, 30, 25, 20, or even not greater than 10; in some embodiments, in a range from 10 to 100, 10 to 25, or even 10 to 50).
22A. The coextruded polymeric layer of any preceding A Exemplary Embodiment having a thickness from the first to the second major surface of the coextruded polymeric layer, wherein there is a gradient of a Shore A values through the thickness from the first to the second major surface.
23A. The coextruded polymeric layer of any preceding A Exemplary Embodiment having a thickness from the first to the second major surface of the coextruded polymeric layer, wherein there is a gradient of average pore sizes that increase toward the second major surface.
24A. The coextruded polymeric layer of any preceding A Exemplary Embodiment, wherein the first and second opposed major surfaces are free of exposed internal porous cells (i.e., less than 10 percent of the surface area of each of the first and second major surface has any exposed porous cells).
25A. The coextruded polymeric layer of any preceding A Exemplary Embodiment, wherein at least 40 (in some embodiments, at least 55, 60, 65, 70, 75, 80, 85, 90, 95, 96, 97, 98, 99, or even 100) percent by area of each major surface has an as-cured surface. 26A. The coextruded polymeric layer of any preceding A Exemplary Embodiment having a thickness up to 25,400 (in some embodiments, in a range from 100 to 1000, 1000 to 6000, 6000 to 12,700 or even 12,700 to 25,400) micrometers.
27A. The coextruded polymeric layer of any preceding A Exemplary Embodiment having a glass transition temperature, T_{g}, in a range from −125° C. to 150° C. (in some embodiments, in a range from −125° C. to −10° C., −10° C. to 80° C., 50° C. to 150° C. or even 50° C. to 80° C.).
28A. The coextruded polymeric layer of any preceding A Exemplary Embodiment having first and second opposed major surfaces, wherein the first and second opposed major surfaces are free of exposed internal porous cells (i.e., less than 10 percent of the surface area of each of the first and second major surface has any exposed porous cells).
29A. The coextruded polymeric layer of any preceding A Exemplary Embodiment comprising at least one copolymer comprising at least one amorphous component.
30A. The coextruded polymeric layer of any preceding A Exemplary Embodiment, wherein the thermoplastic is an amorphous or semi-crystalline polymer or copolymer.
31A. The coextruded polymeric layer of any preceding A Exemplary Embodiment comprising a star polymer.
32A. The coextruded polymeric layer of Exemplary Embodiment 31A, wherein the star polymer comprises at least one of styrene isoprene styrene (SIS), styrene ethylene propylene styrene (SEPS), styrene ethylene butadiene styrene (SEBS), or styrene butadiene styrene (SBS) (including mixtures thereof).
33A. The coextruded polymeric layer of any preceding A Exemplary Embodiment having a compressive stress versus compressive strain value of at least 1 (in some embodiments, at least 5, 10, 100, 1000, or even 6000; in some embodiments, in a range from 1 to 50, 50 to 500, or even 500 to 6000) MPa.
34A. The coextruded polymeric layer of any preceding A Exemplary Embodiment having a yield stress of at least 0.01 (in some embodiments, at least 0.1, 0.5, 1, 5, or even 10; in some embodiments, in a range from 0.01 to 0.1, 0.1 to 1, or even at least 1 to 100) MPa.
35A. The coextruded polymeric layer of any preceding A Exemplary Embodiment having a durometer value less than 20 (in some embodiments, less than 15, 10, or even less than 5; in some embodiments in a range from 1 to 5, 1 to 10, or even 1 to 15).
36A. The coextruded polymeric layer of any preceding A Exemplary Embodiment that can be wrapped around a 1 m (in some embodiments, 75 cm, 50 cm, 25 cm, 10 cm, 5 cm, 1 cm, 5 mm, or even 1 mm) diameter rod without breaking.
37A. The coextruded polymeric layer of any preceding A Exemplary Embodiment, wherein the features comprise at least one of the following shapes: a cone, a cube, a pyramid, a continuous rail, continuous multi-directional rails, a hemisphere, a cylinder, or a multi-lobed cylinder.
38A. The coextruded polymeric layer of any preceding A Exemplary Embodiment, wherein the features have a cross-section in at least one of the following shapes: circle, square, rectangle, triangle, pentagon, other polygon, sinusoidal, herringbone, or multi-lobe.
39A. The coextruded polymeric layer of any preceding A Exemplary Embodiment, wherein the features have a cross-section area in a range from 2 to 400 (in some embodiments, in a range from 2 to 300, 2 to 200, 2 to 100, 2 to 50, or even 2 to 20) square millimeters.
40A. The coextruded polymeric layer of any preceding A Exemplary Embodiment having a total porosity of at least 25 (in some embodiments, at least 30, 35, 40, 45, 50, 55, 60, 65, 70, 75, or even at least 80; in some embodiments, in a range from 25 to 80, 30 to 60, or even 30 to 50) percent, based on the total volume of the polymeric layer.
41A. The coextruded polymeric layer of any preceding A Exemplary Embodiment further comprising a polymer layer on the foam features, wherein the polymer layer comprises polymer different from polymer comprising the polymeric layer.
42A. The coextruded polymeric layer of any preceding A Exemplary Embodiment comprising at least one of glass beads, glass bubbles, glass fibers, abrasive grain, carbon black, carbon fibers, diamond particles, composite particles, nanoparticles, mineral oil, tackifier, wax, rubber particles or flame retardant.
43A. The coextruded polymeric layer of any preceding A Exemplary Embodiment comprising a thermal conductive material (e.g., BN).
44A. The coextruded polymeric layer of any preceding A Exemplary Embodiment comprising an electrically conductive material.
1B. A vibration damping laminate comprising a kinetic spacer comprising the polymeric layer of any preceding A Exemplary Embodiment.
1C. A method of making a coextruded polymeric layer, the method comprising:

providing a rotating tool roll having a major circumferential surface and a coextrusion die with a die lip spaced in proximity of the rotating tool roll to form a gap between the rotating tool roll and the coextrusion die; and

coextruding at least first and second polymers from the coextrusion die onto a portion of the major circumferential surface of the rotating tool roll, wherein at least one of the first or second polymers comprises a forming agent, and wherein the portion of the major circumferential surface is in proximity of the die lip

to provide a coextruded polymeric layer of any preceding A Exemplary Embodiment.
2C. The method of Exemplary Embodiment 1C, wherein the major circumferential surface of the rotating tool roll comprises an array of cavities.
3C. The method of any preceding C Exemplary Embodiment, wherein the major circumferential surface of the compression roll comprises an array of cavities.
4C. The method of any preceding C Exemplary Embodiment, wherein the major circumferential surface of the rotating tool roll comprises an array of protrusions.
5C. The method of any preceding C Exemplary Embodiment, wherein the foaming agent comprises at least one of an acid (e.g., citric acid), bicarbonate, azodicarbonamide, modified azodicarbonamide, hydrazide, sodium bicarbonate and citric acid blend, dinitrosopentamethylenetetramine, p-toluenesulfonyl hydrazide. 4-4′-oxybis hydrazide, azodicarbonamide, p-toluenesulfonyl semicarbazide, 5-phenyltetrazole, 5-phenyltetrazole analogues, diisopropylhydrazodicarboxylate, 5-phenyl-3,6-dihydro-1,3,4-oxadiazin-2-one, or sodium borohydride.
1D. A method of making a coextruded polymeric layer, the method comprising:

providing a rotating tool roll having a major circumferential surface and a coextrusion die with a die lip spaced in proximity of the rotating tool roll to form a gap between the rotating tool roll and the coextrusion die; and

coextruding at least first and second polymers from the coextrusion die onto a portion of the major circumferential surface of the rotating tool roll, wherein the portion of the major circumferential surface is in proximity of the die lip, wherein a gas is injected into at least one of the first or second polymers prior the polymer contacting the portion of the major circumferential surface of the rotating tool roll and, wherein the extruded polymer foams

to provide the coextruded polymeric layer of any preceding A Exemplary Embodiment.
2D. The method of Exemplary Embodiment 1D, wherein the major circumferential surface of the rotating tool roll comprises an array of cavities.
3D. The method of any preceding D Exemplary Embodiment, wherein the major circumferential surface of the rotating tool roll comprises an array of protrusions.
4D. The method of any preceding D Exemplary Embodiment, wherein the gas comprises at least one of argon, carbon dioxide, nitrogen, a butane (e.g., n-butane and isobutane), a heptane (e.g., n-heptane, isoheptane, and cycloheptane), a hexane (e.g., n-hexane, neohexane, isohexane, and cyclohexane), an octane (e.g., n-octane and cyclooctane), or a pentane (e.g., n-pentane, cyclopentane, neopentane, and isopentane).
1E. A method of making a coextruded polymeric layer, the method comprising:

providing a rotating tool roll having a major circumferential surface and a coextrusion die with a die lip spaced in proximity of the rotating tool roll to form a gap between the rotating tool roll and the coextrusion die; and

introducing a polymer comprising polymeric microspheres onto a portion of the major circumferential surface of the rotating tool roll, wherein the portion of the major circumferential surface is in proximity of the die lip, and wherein the polymer foams
to provide a coextruded polymeric layer of any preceding A Exemplary Embodiment.
2E. The method of Exemplary Embodiment 1E, wherein the major circumferential surface of the rotating tool roll comprises an array of cavities.
3E. The method of any preceding E Exemplary Embodiment, wherein the major circumferential surface of the rotating tool roll comprises an array of protrusions.
4E. The method of any preceding E Exemplary Embodiment, wherein the polymeric microspheres comprise expanding bubbles.
1F. A method of making a coextruded polymeric layer, the method comprising:

providing a rotating tool roll having a major circumferential surface;

providing a coextrusion die with a die lip spaced in proximity of the rotating tool roll to form a gap between the rotating tool roll and the coextrusion die;

providing a compression roll in proximity of the rotating tool roll to form a gap between the rotating tool roll and the compression roll;

injecting oil into a polymer comprising at least one of a foaming agent, a gas, or polymeric microspheres in an extrusion chamber; and

extruding the polymer into the gap between the coextrusion die and the rotating tool roll, wherein the polymer foams

to provide the coextruded polymeric layer of any preceding A Exemplary Embodiment.
2F. The method of Exemplary Embodiment 1F, wherein the major circumferential surface of the rotating tool roll comprises an array of cavities.
3F. The method of any preceding F Exemplary Embodiment, wherein the major circumferential surface of the rotating tool roll comprises an array of protrusions.
4F. The method of any preceding F Exemplary Embodiment further comprising a compression roll having a major circumferential surface positioned near the coextrusion die, down web.
5F. The method of Exemplary Embodiment 4F, wherein the major circumferential surface of the compression roll comprises an array of cavities.
6F. The method of either Exemplary Embodiment 4F or 5F, wherein the major circumferential surface of the compression roll comprises an array of protrusions.
7F. The method of any preceding F Exemplary Embodiment, wherein the oil comprises at least one of a lanolin, a liquid polyacrylate, a liquid polybutene, a mineral oil, or a phthalate.
8F. The method of any preceding F Exemplary Embodiment, wherein the foaming agent comprises at least one of an acid (e.g., citric acid), a bicarbonate, an azodicarbonamide, a modified azodicarbonamide, a hydrazide, a sodium bicarbonate and citric acid blend, dinitrosopentamethylenetetramine, p-toluenesulfonyl hydrazide. 4-4′-oxybis hydrazide, azodicarbonamide, p-toluenesulfonyl semicarbazide, 5-phenyltetrazole, a 5-phenyltetrazole analogue, diisopropylhydrazodicarboxylate, 5-phenyl-3,6-dihydro-1,3,4-oxadiazin-2-one, or sodium borohydride.
9F. The method of any preceding F Exemplary Embodiment, wherein the gas comprises at least one of argon, carbon dioxide, nitrogen, a butane (e.g., n-butane and isobutane), a heptane (e.g., n-heptane, isoheptane, and cycloheptane), a hexane (e.g., n-hexane, neohexane, isohexane, and cyclohexane), an octane (e.g., n-octane and cyclooctane), or a pentane (e.g., n-pentane, cyclopentane, neopentane, and isopentane).
10F. The method of any preceding F Exemplary Embodiment, wherein the polymeric microspheres comprise expanding bubbles.
11F. The method of any preceding F Exemplary Embodiment, wherein the oil is at a temperature greater than 80° C. (in some embodiments, at least 90° C., 100° C., 125° C., 150° C., 175° C., or even, at least 200° C.; in some embodiments, in a range from 80° C. to 250° C., 100° C. to 250° C., or even 100° C. to 200° C.).
1G. A method of making a coextruded polymeric layer, the method comprising:

providing a rotating tool roll having a major circumferential surface and a coextrusion die with a die lip spaced in proximity of the rotating tool roll to form a gap between the rotating tool roll and the coextrusion die; and

introducing reactive polymer onto a portion of the major circumferential surface of the rotating tool roll, wherein the portion of the major circumferential surface is in proximity of the die lip and wherein the reactive polymer foams and at least partially polymerizes

to provide the coextruded polymeric layer of any preceding A Exemplary.
2G. The method of Exemplary Embodiment 1G, wherein the reactive polymer reacts after forming to increase the molecular weight of the coextruded polymeric layer.
3G. The method of any preceding G Exemplary Embodiment, wherein the reactive polymer reacts to crosslink the coextruded polymeric layer.
4G. The method of any preceding G Exemplary Embodiment, wherein the reactive polymer reacts with moisture to cause polymerization or crosslinking of the coextruded polymeric layer. 5G. The method of any preceding G Exemplary Embodiment, wherein the reactive polymer comprises isocyanate functional groups, alkoxysilane functional groups, or ketimine functional groups.
6G. The method of any preceding G Exemplary Embodiment, wherein the reactive polymer comprises at least one of a (meth)acrylic functional group, an allyl functional group, or a vinyl functional group.
7G. The method of any preceding G Exemplary Embodiment including exposing the reactive polymer to at least one of gamma radiation, E-beam radiation, or UV-radiation to cause at least one of polymerization or crosslinking of the coextruded polymeric layer.
8G. The method of any preceding G Exemplary Embodiment, wherein the major circumferential surface of the rotating tool roll comprises an array of cavities.
9G. The method of any preceding G Exemplary Embodiment, wherein the major circumferential surface of the rotating tool roll comprises an array of protrusions.
10G. The method of any preceding G Exemplary Embodiment further comprising a compression roll having a major circumferential surface positioned near the coextrusion die, downweb.
11G. The method of any of Exemplary Embodiments 1G to 7G, wherein the major circumferential surface of the compression roll comprises an array of cavities.
12G. The method of either Exemplary Embodiment 10G or 11G, wherein the major circumferential surface of the compression roll comprises an array of protrusions.
1H. A method of making a coextruded polymeric layer, the method comprising:

providing a rotating tool roll having a major circumferential surface and a coextrusion die with a die lip spaced in proximity of the rotating tool roll to form a gap between the rotating tool roll and the extrusion die;

providing an extruder connected to the coextrusion die;

introducing a reactive monomer into the extruder, wherein the reactive monomer at least partially polymerizes in the extruder and coextrusion die to form a polymer; and

injecting the polymer from the coextrusion die onto a portion of the major circumferential surface of the rotating tool roll, wherein a portion of the major circumferential surface is in proximity of the die lip and wherein the polymer foams

to provide the coextruded polymeric layer of any preceding A Exemplary Embodiment.
2H. The method of Exemplary Embodiment 1H, further comprising injecting a reactive polymer into the extruder with the reactive monomer, wherein the monomer has a molecular weight, and wherein the monomer at least partially reacts with the reactive polymer to form a polymer having a higher molecular weight than the molecular weight of the monomer.
3H. The method of Exemplary Embodiment 2H, wherein the reactive monomer comprises a polyisocyanate and a polyol, and wherein the polymer formed from the reaction of the monomer and the reactive polyisocyanate is a polyurethane.
4H. The method of Exemplary Embodiment 3H, wherein the reactive monomer further comprises a hydroxyl-functional chain extender.
5H. The method of either Exemplary Embodiment 3H or 4H, wherein the ratio by number of isocyanate equivalents hydroxyl equivalents is in a range from is 0.85:1 to 1.2:1 (in some embodiments, in a range from 0.95:1 to 1.05:1 0.95:1 to 1.0:1, or 1.0:1 to 1.06:1).
6H. The method of any of Exemplary Embodiments 3H to 5H, wherein at least one of the polyol or the polyisocyanate has an average functionality of greater than 2.0.
7H. The method of any preceding H Exemplary Embodiment, wherein the major circumferential surface of the rotating tool roll comprises an array of cavities.
8H. The method of any preceding H Exemplary Embodiment, wherein the major circumferential surface of the rotating tool roll comprises an array of protrusions.
9H. The method of any preceding H Exemplary Embodiment further comprising a compression roll having a major circumferential surface positioned near the coextrusion die, downweb.
10H. The method of Exemplary Embodiment 9H, wherein the major circumferential surface of the compression roll comprises an array of cavities.
11H. The method of either Exemplary Embodiment 9H or 10H, wherein the major circumferential surface of the compression roll comprises an array of protrusions.
12H. The method of any preceding H Exemplary Embodiment, wherein the polymer comprises a foaming agent.
13H. The method of Exemplary Embodiment 12H, wherein the foaming agent comprises polymer microspheres.
14H. The method of Exemplary Embodiment 13H, wherein the polymer microspheres are expandable bubbles.
15H. The method of any of Exemplary Embodiments 12H to 14H, wherein the foaming agent comprises at least one of an acid (e.g., citric acid), bicarbonate, azodicarbonamide, modified azodicarbonamide, hydrazide, sodium bicarbonate and citric acid blend, dinitrosopentamethylenetetramine, p-toluenesulfonyl hydrazide, 4-4′-oxybis hydrazide, azodicarbonamide, p-toluenesulfonyl semicarbazide, 5-phenyltetrazole. 5-phenyltetrazole analogues, diisopropylhydrazodicarboxylate 5-phenyl-3,6-dihydro-1,3,4-oxadiazin-2-one, or sodium borohydride.
16H. The method of any of Exemplary Embodiments 12H to 15H, wherein the foaming agent comprises water and isocyanate.
17H. The method of any of Exemplary Embodiments 12H to 15H, wherein the foaming agent comprises a gas comprising at least one of argon, carbon dioxide, nitrogen, a butane (e.g., n-butane and isobutane), a heptane (e.g., n-heptane, isoheptane, and cycloheptane), a hexane (e.g., n-hexane, neohexane, isohexane, and cyclohexane), an octane (e.g., n-octane and cyclooctane), or a pentane (e.g., n-pentane, cyclopentane, neopentane, and isopentane).
1I. A multilayer damping material comprising:

at least one constraining layer;

at least one dissipating layer; and

at least one kinetic spacer layer comprising at least one coextruded polymeric layer of any preceding A Exemplary Embodiment.

1J. A method of providing an article, the method comprising;

providing a coextruded polymeric layer of any preceding A Exemplary Embodiment; and

applying at least one of heat or pressure to permanently deform at least one protrusion of the coextruded polymeric layer.

1K. A polishing pad comprising a coextruded polymeric layer of any preceding A Exemplary Embodiment.
2K. The polishing pad of Exemplary Embodiment 1K, wherein the coextruded polymeric layer further comprises at least one channel, and wherein the channel has a depth greater than the distance the foam features extend from or into the first major surface.
3K. The polishing pad of either Exemplary Embodiment 1K or 2K, further comprising a subpad, wherein the subpad is adjacent to the second major surface of the coextruded polymeric layer.
4K. The polishing pad of any preceding K Exemplary Embodiment having foam features extending at least one of from or into the first major surface (in some embodiments, in a range from 100 micrometers to 20,000 micrometers).
5K. The polishing pad of Exemplary Embodiment 4K, wherein the coextruded polymeric layer includes foam features extending from the first major surface.
1L. A polishing system comprising the polishing pad of any preceding K Exemplary Embodiment and a polishing solution.
2L. The polishing system of Exemplary Embodiment 1L, wherein the polishing solution is a slurry.
1M. A method of polishing a substrate, the method comprising:
providing a polishing pad of any preceding K Exemplary Embodiment having a working surface;
providing a substrate having a first surface;
contacting the working surface of the polishing pad with the first substrate surface; and
moving the polishing pad and the substrate relative to one another while maintaining contact between the working surface of the polishing pad and the first substrate surface,
   wherein polishing is conducted in the presence of a polishing solution.
   2M. The method of polishing a substrate of Exemplary Embodiment 1M, wherein the substrate is a semiconductor wafer.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### Example 1

Example 1 was made using an apparatus as generally shown in FIG. 9. The coextrusion die was 20.3 cm (8 inches) wide (obtained under the trade designation “MASTERFLEX” (Model LD-40) from Cloeren, Orange, Tex.) configured with the die positioned on the top of the rotating tool roll at top dead center. The die was orientated such that the bottom of the die was on the trailing edge of the tooling roll. The bottom die lip had a 3.18 mm (0.125 inch) land. The two extruders are 3.2 cm (1.25 inch) single screw extruders (obtained under the trade designation “KILLION” from Davis-Standard, Pawcatuck, Conn.). The die temperature set points used are shown in Table 1, below.

TABLE 1

| | | | | |
|---|---|---|---|---|
| Heating | 3.18 cm | 3.18 cm | Feed Block, | Coextrusion |
| Zones | (1.25 inch) | (1.25 inch) | ° C. (° F.) | Die, |
| | Single Screw | Single Screw | | ° C. (° F.) |
| | Extruder, ° C. | Extruders, ° C. | | |
| | (° F.) Port A on | (° F.) Port C on | | |
| | Feed Block | Feed Block | | |
| Coextruded | First Layer | Second Layer | | |
| Polymeric | | | | |
| Layer | | | | |
| Zone 1 | 177 (350) | 177 (350) | 190 (375) | 190 (375) |
| Zone 2 | 204 (400) | 204 (400) | | 190 (375) |
| Zone 3 | 218 (425) | 218 (425) | | 190 (375) |
| Zone 4 | 218 (425) | 218 (425) | | |
| Neck Tube | 190 (375) | 190 (375) | | |
| Extruder | 60 | 40 | | |
| RMP | | | | |

A three-layer coextrusion feed block (obtained under the trade designation “CLOEREN FEED BLOCK” from Cloeren, Orange, Tex.) was used with an A-B-C plug. The B port was blocked, and ports A and C were used. The feed block was mounted to the coextrusion die. Two 3.18 cm (1.25 inch) single screw extruders (“KILLION”) were used to feed molten polymer into the feed block and die. The master tool was an aluminum shell with a pattern machined into the outer surface.

A single tooling roll station was used with the die mounted at the top dead center of the roll. The die was mounted on linear slides to move in the up and down direction. The linear motion of the die was controlled by linear actuators to move the die and to control the gap between the die lip and tooling roll.

The roll was nominally 30.5 cm (12 inch) in diameter with a 40.6 cm (16 inch) face width. The tooling roll had internal water cooling with spiral wound internal channels. A 37.5 cm (14.75 inch) outside diameter aluminum tooling shell was mounted onto the outer surface of the roll. The tooling roll shell had rectangular indentations machined into the surface of the aluminum shell. The rectangular indentations were 3.69 mm (0.145 inch) wide by 5.90 mm (0.232 inch) long by 1.20 mm (0.047 inch) deep arranged in a herringbone pattern spaced 0.60 mm (0.024 inch) apart. The corners of the indentations had a 0.75 mm (0.030 inch) radius. The tooling roll was set with a cooling temperature set point of 65.5° C. (150° F.). The gap between the die lip and the rotating tool roll surface was set at 1475 micrometers (0.070 inch). The line speed was 0.80 meter (2.6 feet) per minute.

The polymer blends were manually premixed prior to being fed into the extruders. Polymer for the first layer was a resin blend of 96 weight percent polypropylene (obtained under the trade designation “C700-35N” from Dow Chemical, Midland, Mich.), 2 weight percent blowing agent (obtained under the trade designation “ECOCELL H” from Polyfil Corporation, Rockaway, N.J.) and 2 weight percent by weight white pigment (obtained under the trade designation “1015100S” from Clariant Master Batch Inc, West Chicago, Ill.). Polymer for the second layer was a resin blend of 96 weight percent by weight polypropylene (“C700-35N”), 2 weight percent blowing agent (“ECOCELL H”) and 2 weight percent blue pigment (obtained under the trade designation “CC10122414WE” from PolyOne Corp, Elk Grove Village, Ill.).

A two-layer coextruded polymeric foamed film was produced with 1.2 mm tall foamed features and a 0.79 micrometer (0.031 inch) foam backing (comprised of first and second layers). The density of the foamed layer (i.e., first and second layer) was 30 percent by volume less than the polymer material of which it is made.

An optical image of Example 1 (900) is shown in FIG. 9 with first layer (901) and second layer (902).

### Example 2

Equipment configuration was the same as Example 1, except as noted in Table 2, below.

TABLE 2

| | | | | |
|---|---|---|---|---|
| Heating | 3.18 cm | 3.18 cm | Feed Block, | Coextrusion |
| Zones | (1.25 inch) | (1.25 inch) | ° C. (° F.) | Die, |
| | Single Screw | Single Screw | | ° C. (° F.) |
| | Extruder, ° C. | Extruders, ° C. | | |
| | (° F.) Port A on | (° F.) Port C on | | |
| | Feed Block | Feed Block | | |
| Coextruded | First Layer | Second Layer | | |
| Polymeric | | | | |
| Layer | | | | |
| Zone 1 | 177 (350) | 177 (350) | 190 (375) | 190 (375) |
| Zone 2 | 204 (400) | 204 (400) | | 190 (375) |
| Zone 3 | 218 (425) | 218 (425) | | 190 (375) |
| Zone 4 | 218 (425) | 218 (425) | | |
| Neck Tube | 204 (400) | 204 (400) | | |
| Extruder | 90 | 31 | | |
| RMP | | | | |

The gap between the die lip and the rotating tool roll surface was set at 1930 micrometers (0.076 inch). The line speed was 0.73 meter (2.4 feet) per minute.

The polymer blends were manually premixed prior to being fed into the extruders. Polymer for the first layer was a resin blend of 96 weight percent polypropylene (“C700-35N”), 2 percent by weight blowing agent (“ECOCELL H”) and 2 weight percent white pigment (“1015100S”). Polymer for second layer was a resin blend of 98 weight percent polypropylene (“C700-35N”), and 2 weight percent blue pigment (“CC10122414WE”).

A two-layer coextruded polymeric foamed film was produced with 1.2 mm tall foamed features (first layer) and a 0.79 micrometer (0.031 inch) non-foam backing (primarily the second layer). The density of the foamed layer (first layer) was 30 percent by volume less than the polymer material of which it is made.

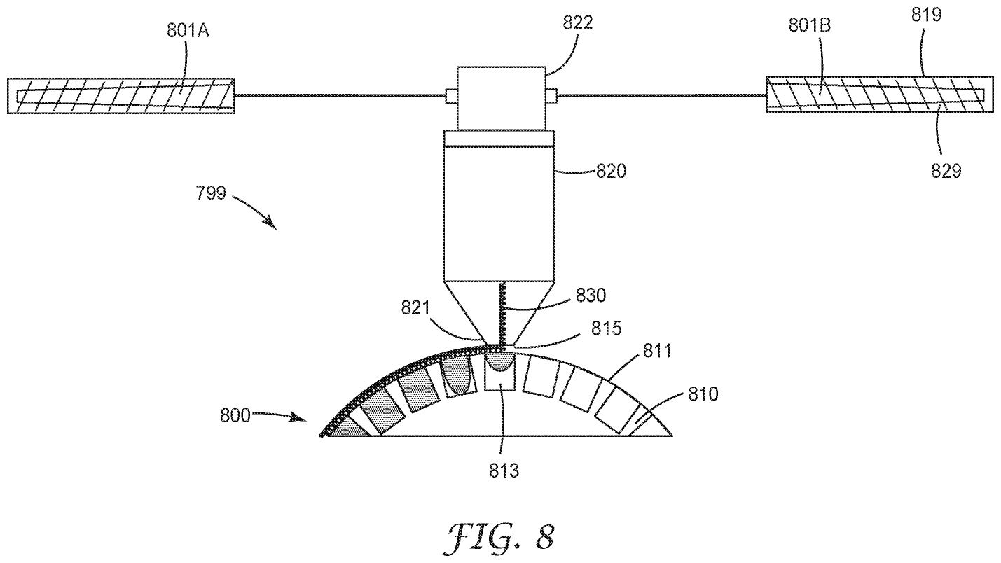

An optical image of Example 2 (1000) is shown in FIG. 10 with first layer (1001) and second layer (1002).

### Example 3

Equipment configuration was the same as Example 1, except as noted in Table 3, below.

TABLE 3

| | | | | |
|---|---|---|---|---|
| Heating | 3.18 cm | 3.18 cm | Feed Block, | Coextrusion |
| Zones | (1.25 inch) | (1.25 inch) | ° C. (° F.) | Die, |
| | Single Screw | Single Screw | | ° C. (° F.) |
| | Extruder, ° C. | Extruders, ° C. | | |
| | (° F.) Port A on | (° F.) Port C on | | |
| | Feed Block | Feed Block | | |
| Coextruded | First Layer | Second Layer | | |
| Polymeric | | | | |
| Layer | | | | |
| Zone 1 | 177 (350) | 177 (350) | 190 (375) | 190 (375) |
| Zone 2 | 204 (400) | 204 (400) | | 190 (375) |
| Zone 3 | 218 (425) | 218 (425) | | 190 (375) |
| Zone 4 | 218 (425) | 218 (425) | | |
| Neck Tube | 204 (400) | 204 (400) | | |
| Extruder | 70 | 20 | | |
| RMP | | | | |

The gap between the die lip and the rotating tool roll surface was set at 1397 micrometers (0.055 inch). The line speed was 0.73 meter (2.4 feet) per minute.

The polymer blends were manually premixed prior to being fed into the extruders. Polymer for the first layer was a resin blend of 97 weight percent (obtained under the trade designation “KRATON D1114” from Kraton Corp., Houston, Tex.) and 3 weight percent blowing agent (“ECOCELL H”). Polymer for the second layer was a resin blend of 98 weight percent polypropylene (“C700-35N”) and 2 weight percent blue pigment (“CC10122414WE”).

A two-layer coextruded polymeric foamed film was produced with 1.2 mm tall foamed features (first layer) and a 0.79 micrometer (0.031 inch) non-foam backing (primarily the second layer). The density of the foamed layer (first layer) was 30 percent by volume less than the polymer material of which it is made.

An optical image of Example 3 (1100) is shown in FIG. 11 with first layer (1101) and second layer (1102).

### Example 4

Equipment configuration was the same as Example 1, except as noted in Table 4, below, unless otherwise noted.

TABLE 4

| | | | | |
|---|---|---|---|---|
| Heating | 3.18 cm | 3.18 cm | Feed Block, | Coextrusion |
| Zones | (1.25 inch) | (1.25 inch) | ° C. (° F.) | Die, |
| | Single Screw | Single Screw | | ° C. (° F.) |
| | Extruder, ° C. | Extruders, ° C. | | |
| | (° F.) Port A on | (° F.) Port C on | | |
| | Feed Block | Feed Block | | |
| Coextruded | First Layer | Second Layer | | |
| Polymeric | | | | |
| Layer | | | | |
| Zone 1 | 177 (350) | 177 (350) | 190 (375) | 190 (375) |
| Zone 2 | 204 (400) | 204 (400) | | 190 (375) |
| Zone 3 | 218 (425) | 218 (425) | | 190 (375) |
| Zone 4 | 218 (425) | 218 (425) | | |
| Neck Tube | 204 (400) | 204 (400) | | |
| Extruder | 26 | 75.6 | | |
| RMP | | | | |

The gap between the die lip and the rotating tool roll surface was set at 1397 micrometers (0.055 inch). The line speed was 0.73 meter (2.4 feet) per minute.

The polymer blends were manually premixed prior to being fed into the extruders. Polymer for the first layer was a resin blend of 98 weight percent polypropylene (“C700-35N”) and 2 weight percent blue (“CC10122414WE”).

Polymer for the second layer was a resin blend of 97 percent by weight (“KRATON D1114”) and 3 weight percent blowing agent (“ECOCELL H”).

A two-layer coextruded polymeric foamed film was produced with 1.2 mm tall non-foamed features (primarily first layer) and a 0.79 micrometer (0.031 inch) foam backing (the second layer). The density of the foamed layer (second layer) was 30 percent by volume less than the polymer material of which it is made.

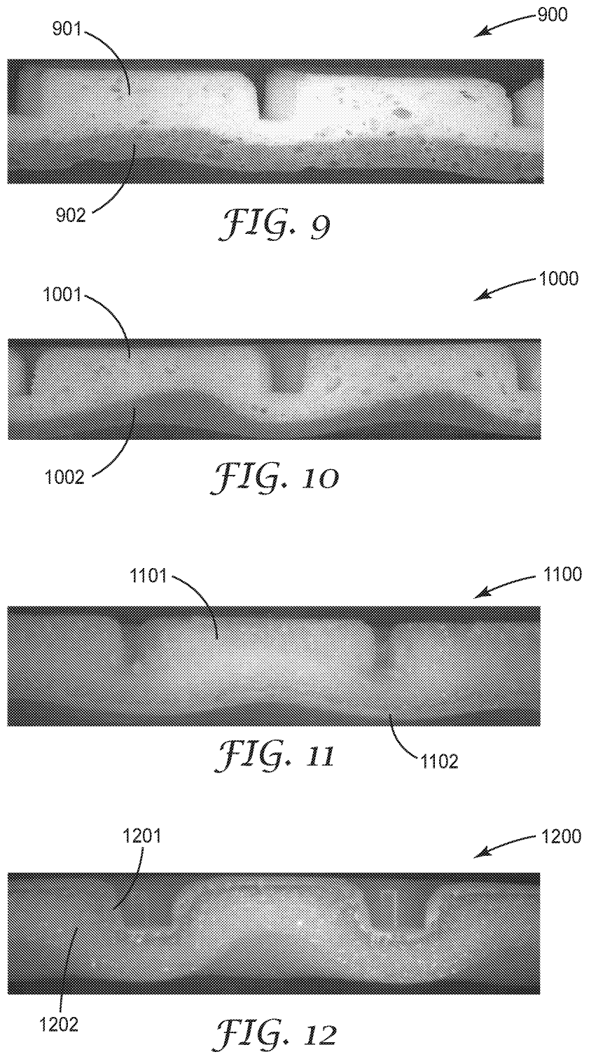

An optical image of Example 4 (1200) is shown in FIG. 12 with first layer (1201) and second layer (1202).

### Example 5

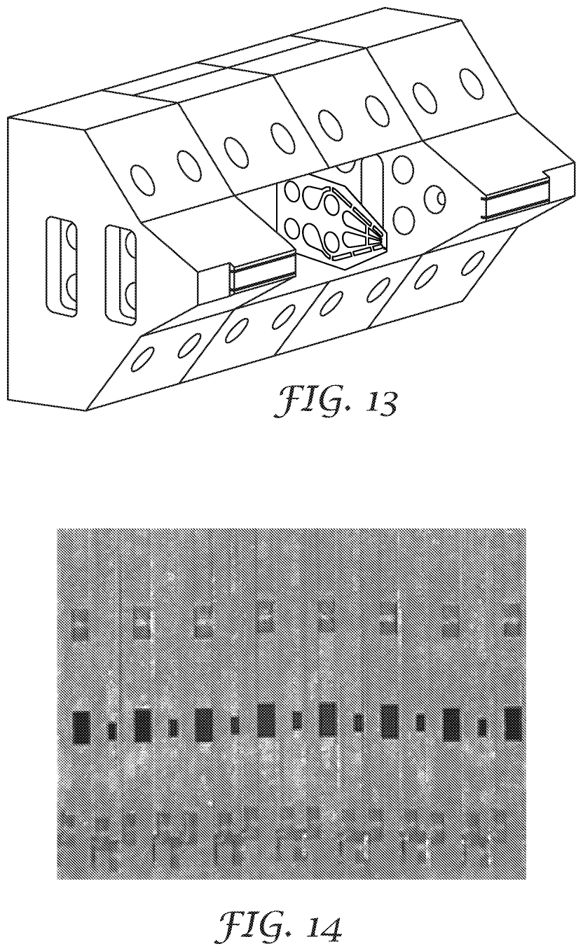

Example 5 was made using an apparatus as generally shown in FIG. 3. The coextrusion die was an A-B side by side shim coextrusion die. The system was configured with the die positioned on the top of the rotating tool roll at top dead center. The die was orientated such that the bottom of the die was on the trailing edge of the tooling roll. The die design used is shown in FIG. 13. The die was constructed as described in Example 13 of U.S. Pat. Pub. No. 2014/0234606 (Ausen et al.), the disclosure of which is incorporated herein by reference, except as follows. Spacers separating the two orifices had a CD width of 0.41 micrometer (0.016 inch). The height and width of the large orifice (Layer B) in both dies were 0.81 micrometer (0.032 inch) and 0.41 micrometer (0.016 inch), respectively. The small orifice (layer A) had a height of and 0.41 micrometer (0.016 inch) and a width of 0.20 micrometer (0.008 inch). An optical image of the die dispensing orifice pattern is shown in FIG. 14.

The two extruders are 3.2 cm (1.25 inch) single screw extruders (“KILLION”). The die temperature set points used are shown in Table 5, below.

TABLE 5

| | | | |
|---|---|---|---|
| Heating | 3.18 cm (1.25 inch) | 3.18 cm (1.25 inch) | Coextrusion |
| Zones | Single Screw | Single Screw | Die, |
| | Extruder, ° C. (° F.) | Extruder, ° C. (° F.) | ° C. (° F.) |
| | Layer A | Layer B | |
| Coextruded | Layer A | Layer B | |
| Polymeric | | | |
| Layer | | | |
| Zone 1 | 177 (350) | 177 (350) | 190 (375) |
| Zone 2 | 204 (400) | 204 (400) | 190 (375) |
| Zone 3 | 218 (425) | 218 (425) | 190 (375) |
| Zone 4 | 218 (425) | 218 (425) | |
| Neck Tube | 204 (400) | 204 (400) | |
| Extruder | 26 | 75.6 | |
| RMP | | | |

A single tooling roll station was used with the die mounted at the top dead center of the roll. The linear motion of the die was controlled by linear actuators to move the die and to control the gap between the die lip and a silicone tooling roll. The die was mounted on linear slides to move in the up and down direction.

The silicone tooling roll was a steel mandrel nominally 30.5 cm (12 inch) in diameter with a 40.6 cm (16 inch) face width having a 70-80 durometer red silicone outer surface. The silicone tooling roll had internal water cooling with spiral wound internal channels. The silicone outer surface was 1.27 centimeter (0.50 inch) thick with a hole pattern in the outer surface with 0.559 micrometer (0.022 inch) diameter indentations machined into the surface of the rubber, 1.30 micrometer (0.050 inch) deep. The indentations were patterned in a rectangular array with a spacing of 1.65 micrometer (0.065 inch) center to center. The silicone tooling roll was set with a cooling temperature set point of 80° C. (175° F.). The gap between the die lip and the rotating tool roll surface was set at 0.762 micrometer (0.030 inch). The line speed was 0.61 meter (2.0 feet) per minute.

The polymer blends were manually premixed prior to being fed into the extruders. Polymer for layer A was a resin blend of 98 weight percent polypropylene (“C700-35N”) and 2 weight percent blue (“CC10122414WE).

Polymer for the second layer was a resin blend of 97 weight percent (“KRATON D1141”) and 3 weight percent blowing agent (“ECOCELL H”).

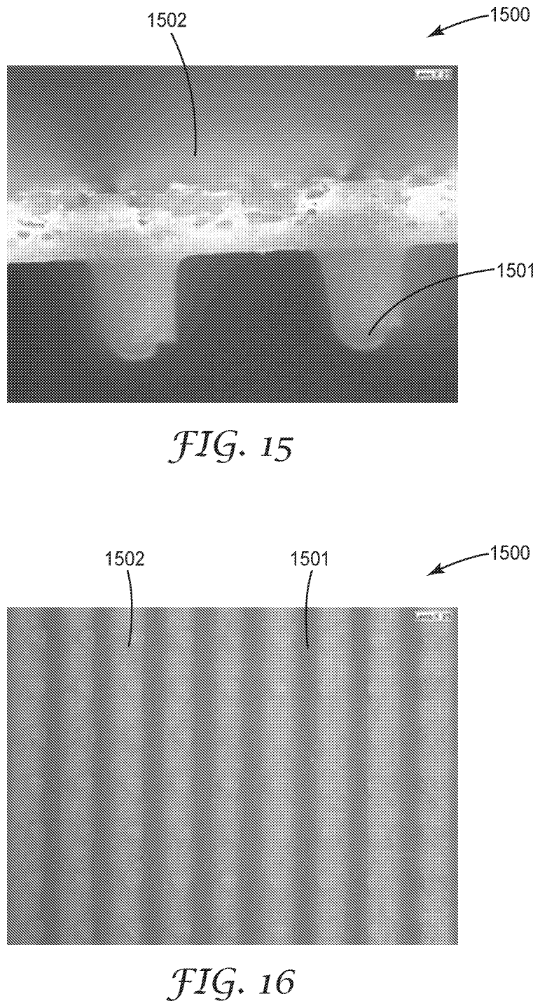

A coextruded mutlilayer polymeric foamed film was produced with 1.52 micrometer (0.060 inch) tall features some of which are foamed and some not foamed and a 1 micrometer (0.040 inch) thick backing that alternates from a foamed section to a non-foamed section with the foamed sections. The foamed sections were 30 percent by volume less than the polymer material of which they were made. There was no alignment between the A-B layers on the die relative to the pattern on the rotating tool roll. Optical images of Example 5 (1500) are shown in FIGS. 15 (cross-sectional view) and 16 (a top view) with first layer (1501) and second layer (1502).

Foreseeable modifications and alterations of this disclosure will be apparent to those skilled in the art without departing from the scope and spirit of this invention. This invention should not be restricted to the embodiments that are set forth in this application for illustrative purposes.

1. A coextruded polymeric layer having first and second opposed major surfaces, the coextruded polymeric layer comprising foam and the coextruded polymeric layer comprising features extending from or into the first major surface by at least 100 micrometers, the first major surface comprising a first material having a first percent elongation at break, the second major surface comprising a second material having a second percent elongation at break, wherein the first percent elongation at break is greater than 100 percent of the second percent elongation at break.

2. The coextruded polymeric layer of claim 1, wherein the second material's percent elongation at break is not greater than 100 percent.

3. The coextruded polymeric layer of claim 1, wherein the polymeric material comprises at least one of polycarbonate, a polyacrylic, a polymethacrylic, an elastomer, a styrenic block copolymer, a styrene-isoprene-styrene, a styrene-ethylene/butylene-styrene block copolymer; a polybutadiene, a polyisoprene, a polychloroprene, a random copolymer of styrene and diene styrene-butadiene rubber, a block copolymer of styrene and diene styrene-butadiene rubber, an ethylene-propylene-diene monomer rubber; a natural rubber, an ethylene propylene rubber, a polyethylene-terephthalate, a polystyrene-polyethylene copolymer, a polyvinylcyclohexane, a polyacrylonitrile, a polyvinyl chloride, a thermoplastic polyurethane, an aromatic epoxy, an amorphous polyester, an amorphous polyamides, a semicrystalline polyamide, an acrylonitrile-butadiene-styrene copolymer, a polyphenylene oxide alloy, a high impact polystyrene, a polystyrene copolymer, a polymethylmethacrylate, a fluorinated elastomer, a polydimethyl siloxane, a polyetherimide, an amorphous fluoropolymer, an amorphous polyolefin, a polyphenylene oxide, or a polyphenylene oxide-polystyrene alloy.

4. The coextruded polymeric layer of claim 1 that is comprised of first and second layers each having first and second major surfaces, wherein the first major surface of the coextruded polymeric layer is the first major surface of a first layer, and wherein the second major surface of the coextruded polymeric layer is the second major surface of a second layer.

5. The coextruded polymeric layer of claim 4, wherein the second layer comprises at least one of an open mesh or a nonwoven.

6. The coextruded polymeric layer of claim 4, wherein the first layer comprises at least one of an elastomer, a styrenic block copolymer, a styrene-isoprene-styrene, a styrene-ethylene/butylene-styrene block copolymer, a polybutadiene, a polyisoprene, a polychloroprene, a random copolymer of styrene and diene styrene-butadiene rubber, a block copolymer of styrene and diene styrene-butadiene rubber, an ethylene-propylene-diene monomer rubber, a natural rubber, a polyurethane, or an ethylene propylene rubber.

7. The coextruded polymeric layer of claim 4, wherein the second layer comprises at least one of polypropylene, polyethylene, polyolefin, a polycarbonate, a polyacrylic, a polymethacrylica polyethylene-terephthalate, a polystyrene-polyethylene copolymer, a polyvinylcyclohexane, a polyacrylonitrile, a polyvinyl chloride, a thermoplastic polyurethane, an aromatic epoxy, an amorphous polyester, an amorphous polyamides, a semicrystalline polyamide, an acrylonitrile-butadiene-styrene copolymer, a polyphenylene oxide alloy, a high impact polystyrene, a polystyrene copolymer, a polymethylmethacrylate, a fluorinated elastomer, a polydimethyl siloxane, a polyetherimide, an amorphous fluoropolymer, an amorphous polyolefin, a polyphenylene oxide, or a polyphenylene oxide-polystyrene alloy.

8. The coextruded polymeric layer of claim 1, wherein the first major surface has a Shore A value not greater than 100.

9. The coextruded polymeric layer of claim 1, wherein the first major surface has a Shore A value of at least 1.

10. The coextruded polymeric layer of claim 1, wherein the first major surface has a Shore 00 value of at least 10.

11. The coextruded polymeric layer of claim 1, wherein the first major surface of the coextruded polymeric layer has a Shore A value in a range from 1 to 100.

12. The coextruded polymeric layer of claim 1, wherein the second major surface has a Shore D value of at least 10.

13. The coextruded polymeric layer of claim 1, wherein the second major surface has a Shore D value not greater than 100.

14. The coextruded polymeric layer of claim 1 having a thickness from the first to the second major surface of the coextruded polymeric layer, wherein there is a gradient of a Shore A values through the thickness from the first to the second major surface.

15. A vibration damping laminate comprising a kinetic spacer comprising the coextruded polymeric layer of claim 1.
